(19) United States
(12) Patent Application Publication
(10) Pub. No.: US 2007/0244682 A1
(43) Pub. Date: Oct. 18, 2007

(54) Estimating Gene Networks Using Inferential Methods and Biological Constraints

(75) Inventors: Sascha Ott, Tokyo (JP); Satoru Miyono, Tokyo (JP)

Correspondence Address: WILSON SONSINI GOODRICH & ROSATI, 650 PAGE MILL ROAD, PALO ALTO, CA, 94304-1050, US

(73) Assignees: GNI LTD., Tokyo (JP); GNI USA, San Jose, CA (US)

(21) Appl. No.: 10/582,245

(22) PCT Filed: Dec. 13, 2004
(86) PCT No.: PCT/US04/42027

§ 371 Date: May 9, 2007

Related U.S. Application Data
(60) Provisional application No. 60/529,146, filed on Dec. 12, 2003.

(51) Int. Cl. G06G 7/60

(52) U.S. Cl. 703/11

(57) ABSTRACT

The accurate estimation of gene networks from gene expression measurements is a major challenge in the field of Bioinformatics. We present a general approach to reduce the search space to a biologically meaningful subspace and to find optimal solutions within the subspace in linear time by using inferential models constrained by biologically relevant information. We showed the effectiveness of this approach in application to yeast and Bacillus subtilis data. Also, we provide systems and storage media adapted to provide and store data and results of gene network relationships.

### PRIORITY CLAIM

This application claims priority to U.S. Provisional Patent Application No: 60/529,146, entitled ESTIMATING GENE NETWORKS USING INFERENTIAL METHODS AND BIOLOGICAL CONSTRAINTS, by Sascha Ott and Satoru Miyano, filed Dec. 12, 2003, (Attorney Docket No. GENN-01011US0) herein incorporated fully by reference.

### FIELD OF THE INVENTION

This invention relates to estimating gene networks in biological systems using mathematical inferential methods using biological constraints. In particular, this invention relates to estimating gene networks using Bayesian estimation, with search fields limited by understanding of the biological constraints on the genetic system.

### BACKGROUND

Inference of gene networks from gene expression measurements is a major challenge in Systems Biology. If gene networks can be inferred correctly, it can lead to a better understanding of cellular processes, and, therefore, have applications to drug discovery, disease studies, and other areas. Estimation of gene networks from expression level measurements is one focus of Bioinformatics research.

A frequently used approach to model gene networks are Bayesian networks. In Bayesian networks, the behavior of the network is described by a joint probability distribution for the expression levels of all genes in a relevant group of genes from an organism. A joint probability distribution can be decomposed in conditional probability distributions using a directed acyclic graph, which we can call a network. A number of score functions have been proposed for the selection of the network, given gene expression measurement data. Work on new score functions exploiting previous knowledge is on-going. Networks are scored using score functions based on the likelihood of networks, given the data. Having selected a score function, the task of estimating a gene network is to find a network with minimal score.

However, facing the NP-hard gene network estimation problem and a search space of super-exponential size, some have applied heuristic algorithms, for example, greedy algorithms or simulated annealing in order to estimate gene networks. Since heuristic algorithms do not provide any assurance of their accuracy, it remains unclear to which extent a network estimation will be biased by the computational method used.

One can deduce an optimal gene network model with respect to some data for gene networks of about 30 genes or less. This result holds for any score function s:G×2^{G} assigning a score to a gene g and a set of parents for g However, while optimal gene network models are the most likely models, there may still be very different models that have approximately the same likelihood with respect to some data, especially since gene expression measurements will in general provide only partial information about the gene network. Furthermore, even for a gene network of only 10 genes, there are about 4.17*10¹⁸ possible network models. Therefore, even optimal gene network models will in general not match the target gene network.

### SUMMARY

In certain aspects of this invention, we present methods to estimate gene networks efficiently, though providing optimality of the estimated network in a restricted sense. First, an inferential model of possible gene networks is created. Second, a biologically relevant subspace of the search space is selected. Then, we find optimal solutions in the selected subspace by repeatedly applying an algorithm that computes small gene networks optimally. The selection of the subspace can be done by applying biological knowledge or, if no previous knowledge is available, for example, by using clustering methods.

In certain embodiments, such an approach allows one to make use of biological knowledge by restricting the search space in a biologically slight but computationally effective way. The approach improves optimality with respect to the restricted search space and therefore provides a clear distinction of the part of the estimation that is done heuristically/empirically, and the part that is done optimally.

In other embodiments, using Bayesian networks, the behavior of the gene network is modeled as a joint probability distribution for all genes. This allows a very general modeling of gene interactions. The joint probability distribution can be decomposed as a product of conditional probabilities, representing the regulation of a gene by other genes. This decomposition can be represented as a directed acyclic graph. Bayesian network models can be used to find biologically plausible gene networks.

Gene expression information can be produced using methods known in the art, including, for example, microarray analyses. As these methods are known in the art, we need not describe them further. However, it can be appreciated that the reliability of network relationships can depend upon the accuracy and/or reliability of the information obtained on gene expression. Therefore, in some embodiments, replicate assays, and controlled studies are desirable to increase the reliability of gene expression data.

In other aspects, we provide the theoretical basis and an algorithm for the enumeration of optimal and suboptimal networks in the order of their likelihood. In further embodiments, we compared optimal gene network models to the available knowledge about existing gene networks. Instill further embodiments, we present an approach to extract the reliable part of optimal gene network models and apply this approach to the available data of B. subtilis and E. coli in order to compare gene network models of related species

Our results show that the partial networks identified by our approach are in significantly better agreement with the knowledge than an optimal network model itself. Since we base our approach on the best n gene network models, one can derive conclusions from these estimations more reliably than from methods that rely on heuristic methods alone.

This invention also includes systems that carry out inferential analysis of gene networks, comprising at least an input device adapted to receive data on gene expression from a number of different genes, and a processor adapted to run a program for inferring gene network relationships. In additional embodiments, a system includes an output device adapted for displaying, printing, or sending results of gene network analysis to remote locations.

### BRIEF DESCRIPTION OF THE FIGURES

This invention is described with reference to specific descriptions of embodiments of the invention and to the figures, in which:

FIG. 1 depicts gene network predicted by Algorithm 3 of Example 1.

FIG. 2a depicts time course data obtained for B. subtilis.

FIG. 2b depicts disruptant data obtained for B. subtilis.

FIG. 3 depicts data obtained from E. coli.

FIG. 4 depicts gene network relationship motifs extracted for E. coli.

FIG. 5 depicts gene network relationship motifs extracted for B. subtilis.

### DETAILED DESCRIPTION

The elucidation of gene interactions in cells is an important focus of research in recent years (20). In certain embodiments, one can model gene networks using Bayesian networks (4,5,6,11,12,14,16,19). In Bayesian networks, the behavior of the network is described by a joint probability distribution for the expression levels of all genes. The joint probability distribution must be decomposed in conditional probability distributions using a directed acyclic graph, or “network.” A number of score functions have been proposed for the selection of the network (3,4,11) given gene expression measurement data. Work on new score functions exploiting previous knowledge is on-going (13,23). Having selected a score function, the task of estimating a gene network is to find a network with minimal score.

However, facing the NP-hard gene network estimation problem (1) and a search space of super-exponential size (17), researchers have applied heuristic algorithms like greedy algorithms (11) or simulated annealing (7) in order to estimate gene networks. Since heuristic algorithms do not provide any assurance on their accuracy, it remains unclear to which extent the network estimation will be biased by the computational method.

In certain aspects of this invention, we present methods to estimate gene networks efficiently, though providing optimality of a network in a restricted sense. First, an inferential model of possible gene networks is created. Second, a biologically relevant subspace of the search space is selected. Then, we find optimal solutions in the selected subspace by repeatedly applying an algorithm that computes small gene networks optimally (15). The selection of the subspace can be done by applying biological knowledge or, if no previous knowledge is available, for example, by using clustering methods.

In certain embodiments, such an approach allows one to make use of biological knowledge by restricting the search space in a biologically slight but computationally effective way. The approach improves optimality with respect to the restricted search space and therefore provides a clear distinction of the part of the estimation that is done heuristically/empirically, and the part that is done optimally.

### EXAMPLES

The following Examples are intended to illustrate aspects of the invention and are not intended to be limiting. Moreover, for each Example, the references are cited in brackets and refer to the list of references at the end of each Example. Other embodiments of this invention can be produced by persons of skill in the art without undue experimentation. All of those embodiments are included within the scope of the invention.

### Example 1

### Finding Optimal Gene Networks Using Biological Constraints

The running time needed to find an optimal solution in the selected subspace is O(n), where n is the number of genes, therefore allowing estimation of arbitrarily large gene networks. We note that this approach can be applied using any score function s of functionality s:G×2^{G}→IR, which is the case for all score functions within the Bayesian network framework, and for most others as well.

We have implemented our method and applied it to yeast data and Bacillus subtilis data. Comparison of the estimated network for Bacillus subtilis to biological knowledge yields a significant agreement.

Necessary notations are introduced in Section 2, the method is explained in detail in Section 3, and results of network estimations are discussed in Section 4.

1.1. Preliminaries

Throughout the example, we will use G to denote the set of genes, for which a gene network is to be predicted, and assume we are given a score function s:G×2^{G}→IR that assigns a score to a gene g∈G and a set of parent genes A⊂G. Given a network N, the score of N is defined as score(N)=_{def}Σ_{g∈G}_{^{S}}(g,P^{N}(g)), where P^{N}(g) denotes the set of g's parents in N. We introduce some notations from (15).

Definition 1.1:

We define F:G×2^{G}→IR as F(g,A)=_{def}min_{B⊂A}_{^{S}}(g,B), for all g∈G and A⊂G. F(g,A) is the best choice of parents for g when choice is restricted to A. Let us use π to denote a permutation π.{1, . . . |A|}→A of a set A⊂G, and Π^{A} to denote the set of all permutations of A.

Definition 1.2:

Let A⊂G. We define as Q^{A}Π^{A}→IR as:

$${Q}^{A} ( π ) {=}_{def} {\sum }_{g ε A} F ( g , \{ h ε A \vert {π}^{- 1} ( h ) < {π}^{- 1} ( g ) \} ) . \qquad ( 1 )$$

for all π∈Π^{A}.

Definition 1.3:

We define M:2^{G}→_{A⊂G}Π^{A} as
M(A)=_{def}min_{π∈Π}_{^{A}}Q^{A}(π) (2)
for all A⊂G.

In (15) it was shown that Q^{A}(π) is an optimal network in the space of all networks for which M(A) is a topological sort and 1 is a permutation which is a topological sort for at least one optimal network on A.

We state the following algorithm from (15) which we will use as a subroutine in this work.

Algorithm 1.1
Step 1: Compute F(g,φ)=s(g,φ) for all g∈G.
Step 2: For all A⊂G, A≠φ and all g∈G compute F(g,A) as min{s(g,A),min_{a∈A}⁻F(g,A−{a})}.
Step 3: Set M(φ)=φ.
Step 4: For all A⊂G, A≠φ, do the following two steps:
Step 4a: Compute
   g*=arg min_{g⊂A}(F(g,A−{g})+Q^{A-{g}}(M(A−{g}))).
Step 4b: For all 1≦i<|A|, set M(A)(i)=M(A−{g*})(i), and M(A)(|A|)=g*.
Step 5: return Q^{G}(M(G)).

Algorithm 1.1 computes function F in Step 1 and Step 2, and function M in Step 3 and Step 4, making use of F. In Step 5, M was used to compute the score of optimal networks. This algorithm was applied to find optimal gene network models for gene networks of up to about 30 genes, but becomes less reliable for large gene networks.

Theorem 1.1 (15) Algorithm 1.1 finds the optimal network using O(n·2ⁿ) dynamic programming steps

1.2 Method

We first proved a theorem, from which we then derive two algorithms for the estimation of large gene networks.

1.2.1 Theoretical Basis

The following derivation prepares a basis for our approach in this Example.

Theorem 1.2

Let m, c∈IN. For each g∈G, let C_{g}⊂G−{g} be a set of candidate parents. Assume that the following two conditions hold.

1. |C_{g}|≦m for all g∈G.

2. The strongly connected components of the graph induced by C_{g}, g∈G, are not larger than c.

Then optimal networks with respect to the selected candidate parents can be found in time O(|G|).

Proof

Let L=(G,E) denote the graph on the set of genes G that is induced by C_{g}, g∈G. That means E contains exactly the edges (h,g) for which h∈G_{g}. holds. Let S₁, . . . , Sₙ⊂G denote the strongly connected components of L. Now let L′=({S₁, . . . , Sₙ}, E′) denote the graph on the strongly connected components with E. defined as:
E′=def{(Si,Sj)∥i≠j,∃g∈Sj:(g,h)∈E}.

Then, by the definition of strongly connected components there is no cycle in L′. W.l.o.g. let us assume that S₁, . . . , Sₙ is a topological sort for L′ which means that there is no edge (Sᵢ, Sⱼ) in L′ with j<i.

Algorithm 1.1, with slight modifications, can be applied to compute optimal networks for G with respect to the selected candidate parents. In order to apply Algorithm 1.1 to a strongly connected component Sᵢ, we modify the algorithm in the following way:

1. In the computation of F in Step 1 and Step 2, we only compute F(g,A) for all g∈Sᵢ and all A⊂C_{g}.

2. We replace the term F(g, A−{g}) in Step 4a (see definition of Algorithm 1) by F(g,(C_{g}=Sᵢ)∪(C_{g}∩A)).

These two changes introduce the restrictions for candidate parents to the algorithm, and allow g∈Sᵢ to have parents outside of Sᵢ. This does not affect the correctness of Algorithm 1.1, since the proof for Theorem 1.1 (15) can be done for the modified Algorithm 1.1 in the same way as for Algorithm 1. We apply Algorithm 1.1 modified in this way to each strongly connected component Sᵢ in an arbitrary order yielding partial networks Nᵢ=(G,Eᵢ) for each i∈1, . . . , n. Then we return the network N=(G,∪n/i=1Eᵢ). By Theorem 1.1, each partial network Nᵢ optimal. From the acyclicity of L′ it follows that N is acyclic. Thus, using the definition score(N)=Σ_{g∈G}_{^{S}}(g,P^{N}(g)), N is an optimal network.

Since we have |Sᵢ|≦c and |C_{g}|≦m, the computation time for one call of Algorithm 1 becomes bound by some constant. Therefore, applying Algorithm 1.1 to all strongly connected components can be done in O(|G|), which completes the proof.

We note that Algorithm 1.1 and the application of Algorithm 1.1 as a subroutine as defined in the proof can be implemented in a way that allows the enumeration of all optimal networks and also the enumeration of suboptimal networks in the order of their rank. The computation time will increase, depending on the number of networks to compute, but stays feasible. This can be valuable in order to assess the stability of estimated networks under minor changes of the score.

1.2.2 Prediction of Large Gene Networks Without Previous Knowledge

By Theorem 1.2, in order to allow an effective network prediction, one can select candidate parents for each gene such that the strongly connected components in the graph containing all candidate interactions can be bound by a constant. Since gene networks are assumed to consist of highly connected blocks, which are sparsely connected to each other (10, 18), this restriction seems to be satisfied in many research settings. Therefore, Theorem 1.2 provides the basis for a general approach of gene network estimation.

In this work, we give two examples of algoriths designed to exploit Theorem 1.2. The first one (Algorithm 1.2) assumes no previous knowledge and detects highly connected blocks by clustering. The second algorithm (Algorithm 1.3) applies biological knowledge to fulfill the restrictions of Theorem 1.2.

Algorithm 1.2
Step 1: Cluster genes in G such that no cluster is larger than c genes.
Step 2: Sort the clusters by decreasing size: C₁, . . . , Cₙ.
Step 3: For each i∈{1, . . . , n} and for each g∈Cᵢ, select up to m candidate parents from C₁∪ . . . ∪Cₙ.
Step 4: Compute an optimal gene network model using Theorem 1.2.

Since the candidate parents for all genes g are chosen from the cluster g is contained in or previous clusters, no cycle in the graph induced by C_{g}, g∈G can span two clusters. Therefore, the strongly connected components are not larger than c, because |Cᵢ|≦c for all clusters Cᵢ, which shows the correctness of Algorithm 1.2.

Genes that belong to the same cluster are correlated and should therefore form a densely connected part of the gene network, while genes that belong to different clusters have a lower correlation and are therefore unlikely to be connected in the gene network. We use k-means clustering with the Pearson correlation as distance measure.

The rational for sorting the clusters by decreasing size is as follows. The clusters at the beginning of the sorting have the strongest restriction for the selection of candidate parents, since there are few previous clusters. To maximize the number of genes, from which candidate parents can be selected, big clusters should be put at the beginning.

We note that the restrictions of the subspace imposed by Step 1 and Step 2 still allow any two genes to be connected, restricting only the direction of edges for some pairs of genes.

There are many reasonable criteria for the selection of a candidate parent h for a gene g in Step 3. Examples are the correlation of genes or s(g,{h}). In our implementations, we made use of the latter criteria.

1.2.3 Prediction of Large Gene Networks Using Previous Knowledge

If there is previous knowledge about the gene network concerning the densely connected components and the direction of the interaction of genes in different components, the following algorithm can be applied.

Algorithm 1.3
Step 1: Group genes in G in groups Cᵢ with |Cᵢ|≦c and sort them according to biological knowledge: C₁, . . . , Cₙ
Step 2: For each i∈{1, . . . , n} and for each gene g∈Cᵢ, select up to m candidate parents from C₁∪ . . . ∪Cᵢ.
Step 3: Compute an optimal gene network model using Theorem 2.

As for Algorithm 1.2, the correctness of Algorithm 1.3 follows directly from the way candidate parents are chosen in Step 2. An example where not only the densely connected components, but also their order is known, are genes that are activated in specific phases of the cell cycle. In situations where the knowledge about densely connected components and/or their order is partial knowledge, a combination of Algorithm 1.2 and Algorithm 1.3 can be used.

1.3 Results

We have implemented Algorithm 1.2 and Algorithm 1.3, making use of an existing implementation of Algorithm 1.1 (15), and publicly available clustering software (8). As score function s, we chose the BNRC score (11), since it can model non-linear gene interactions and can handle the gene expression data without discretization.

1.3.1 Application of Algorithm 1.2 to Bacillus subtilis Data

We have applied Algorithm 1.2 to Bacillus subtilis data (9). We selected the data for 6 sigma factors and 79 operons known to be regulated by the chosen sigma factors (21). The expression ratios of operons were defined as the average of the expression ratios of their respective genes. Therefore, we have 79 known regulatory interactions in this network of 85 genes resp. operons and will identify a significant part of these, if Algorithm 1.2 has predictive power. We set parameter m, the maximal number of selected candidate parents, to 15, and parameter c, the maximal size of clusters, to 25. The actual size of clusters computed in Step 1 ranged from 8 to 24. For this computation, we used a Sun Fire 15K supercomputer with 96 CPUs, 900 MHz each, for about one hour.

In order to evaluate the biological significance of the estimated network, we computed the distance of each operon to each sigma factor in the network predicted by Algorithm 1.2, where we defined the distance as the minimal number of edges on an undirected path connecting the operon and the sigma factor. When the correct sigma factor was closer to an operon than all other sigma factors, we rated the regulatory relationship as detected. This allows one to compute the p-values for our estimation result, since for a meaningless predictor the probability of detecting regulatory interactions would be at most 1/6. The actual probability is lower than <<equation:GIW20146>>, because we count breaking ties as undetected.

TABLE 1.1
Application of Algorithm 1.2 to Bacillus subtilis data.

| Sigma Factor | Relations Found | Known Relations | p-value |
|---|---|---|---|
| sigE | 8 | 22 | 0.021 |
| sigD | 5 | 16 | 0.113 |
| sigW | 12 | 21 | 20147 |
| sigH | 1 | 11 | 0.865 |
| sigX | 0 | 5 | 1.0 |
| sigF | 0 | 4 | 1.0 |

Table 1.1 shows the result of this evaluation scheme. We observe that the estimated gene network is of significant agreement to the biological knowledge for two sigma factors, 20148 and 20149. This shows that the estimation result contains valuable biological information. We note that a majority of the undetected regulatory relationships were breaking ties, and therefore the distance of operons to their correct sigma factors was still minimal, but one or more of the other sigma factors were as close. We observe that the especially strong significance for 20150 is consistent with a result from [CITE:dehoon03b] for differential equation networks. Therefore, it is likely that the data set is more informative for the region of the gene network that is around 20151 than for other regions.

We note that there is little work on the problem to evaluate the quality of gene network estimations in a principled way. To our knowledge, there is only one other publication that gives a well-defined p-value to prove the significance of estimations [CITE:dehoon03b]. There are several problems that one encounters when doing a principled evaluation of gene network estimations. Examples are the incompleteness of knowledge about gene networks, and the uncertainty about what part of a gene network is working under which experimental conditions. Furthermore, if structural differences between the true gene network and the estimated network are found, it should be distinguished between substantially wrong differences and admissible differences like transitive edges. The above approach of analyzing shortest paths in estimated networks is one way to tackle some of these problems, but work on these problems should be further pursued.

1.3.2 Application of Algorithm 1.3 to Cell Cycle Data

Algorithm 1.3 is based on the application of previous knowledge in order to find a biologically meaningful subspace. Here, we apply Algorithm 1.3 to RNA microarray data for Saccharomyces cerevisiae obtained from time-course experiments using synchronised cell cultures (22). This data set can be expected to contain some information about the gene network that works during the cell cycle of yeast.

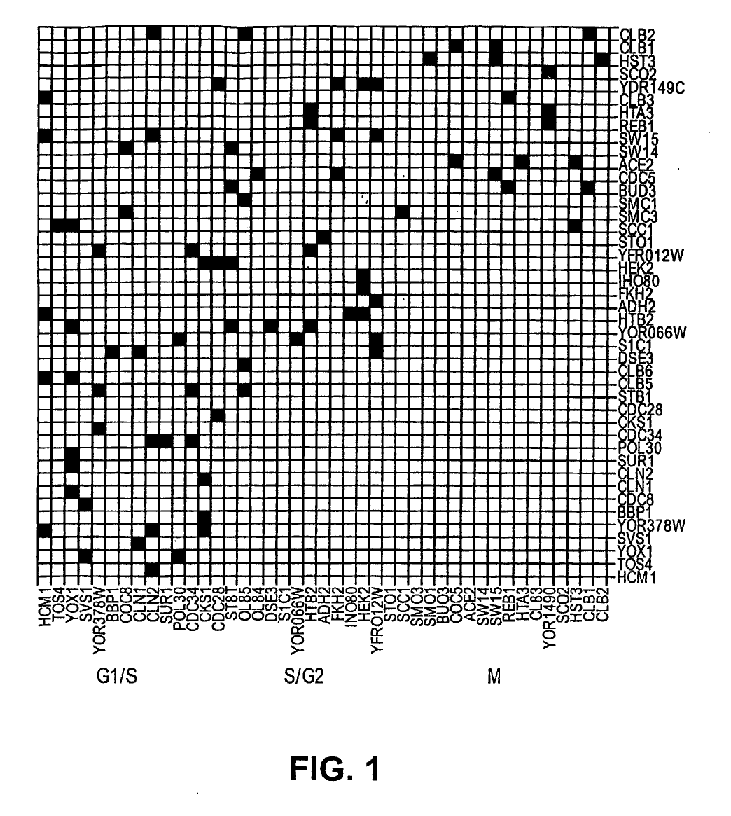

It is known that the three gene pairs cln1/cln2, clb5/clb6, and clb1/clb2 are activated specifically during the G1/S phase, the S phase, resp. the M phase of the cell cycle (2). By a clustering analysis based on this fact several genes were predicted to be predominantly activated during one of these phases (13). We selected a set of 43 genes, divided them into three groups, each group corresponding to one part of the cell cycle. We sorted these groups according to the time order of the cell cycle phases (Step 1 of Algorithm 1.3), set the maximum number of candidate parents (parameter) to 20, and applied Algorithm 1.3 to estimate a gene network. The computation was done using a single CPU with 1.9 GHz for less than one hour. FIG. 1 shows the estimation result.

We observe a total number of 87 predicted gene interactions. Table 1.2 shows the number of directed interactions from a first gene to a second gene partitioned by the groups (rows) and (columns) the genes belong to. We see that 52 out of 87 interactions are within groups, well reflecting the expectation that most interactions occur between genes that are predominantly active during the same phase of the cell cycle. 35 interactions are estimated for pairs of genes from different groups. The number of interactions between two groups is 13 for each of the temporal neighbors G1/S and S/G2, respectively, S/G2 and M, but only 9 for the interactions from G1/S phase to M phase. Therefore, though the gene network estimation is based on a decomposition of the set of genes in three groups, interactions between groups are well accounted for.

TABLE 1.2
Number of Predicted Interactions by Gene Groups

| | | | |
|---|---|---|---|
| 9 | 13 | 18 | M |
| 13 | 16 | | S/G2 |
| 18 | | | G1/S |
| G1/S | S/G2 | M | |

We counted the number of interactions for each gene, which is the number of parents of 20158 plus the number of children of that gene. The genes with the highest number of predicted interactions in the estimated gene network (FIG. 1) are listed in Table 1.3, which also gives the molecular function of these genes as annotated by the Saccharomyces Genome Database. We observed that all genes with at least 7 predicted interactions have regulatory activity on the transcriptional level or have a yet unknown function. Among the three genes with 6 predicted interactions one gene (hcm1) had regulatory function on the transcriptional level, while the two others are cell cycle dependent signaling proteins. We conclude that all genes with a higher number of predicted interactions have a known active regulatory role or are of unknown function. This showed that the estimated gene network contains at least some degree of biological information.

The observation that the important genes cln2 and clb5 have a lower rank within the group of genes in Table 1.3 may be explained by their role in signaling which is observable from mRNA measurements only in an indirect way. Interestingly, swi5 is predicted to be regulated by fkh2 which is a known regulatory relation [CITE:zhu00]. Therefore, the activity of the other genes on the transcriptional level is expected to be more easily observable.

TABLE 1.3
Molecular Functions of Genes With
at Least 6 Predicted Interactions

| | Number of | |
|---|---|---|
| 22 cm Gene | Interactions | 25 cm Molecular Function |
| yfr012w | 8 | unknown |
| yox1 | 7 | DNA binding, specific transcriptional |
| | | represser activity |
| stb1 | 7 | transcriptional activator activity |
| htb2 | 7 | DNA binding |
| hek2 | 7 | mRNA binding |
| swi5 | 7 | transcriptional activator activity |
| ydr149c | 7 | unknown |
| hcm1 | 6 | specific RNA polymerase II |
| | | transcription factor activity |
| cln2 | 6 | cyclin-dependent protein kinase, |
| | | intrinsic regulator activity |
| clb5 | 6 | cyclin-dependent protein kinase, |
| | | intrinsic regulator activity |

Table 1.4 shows on the contrary the genes with the lowest number of predicted interactions. We find several genes with metabolic or signaling functions, one gene of unknown function, one mRNA binding gene (sto1), and one transcription factor (swi4). Since sto1 is known to be involved in nuclear splicing, a regulatory role is less likely. Therefore, only one out of the 11 genes with lowest number of predicted interactions has a known regulatory function on the transcriptional level, which is biologically plausible, since many signaling events will not be observable from mRNA measurements. We conclude that gene network estimations can give more insight to the function of genes than mere clustering results.

TABLE 1.4
Molecular Functions of Genes with
at Most 2 Predicted Interactions

| | Number of | |
|---|---|---|
| 22 cm Gene | Interactions | 25 cm Molecular Function |
| sco2 | 1 | unknown |
| sto1 | 1 | mRNA binding |
| bbp1 | 2 | structural constituent of cytoskeleton |
| sur1 | 2 | transferase activity, transferring glycosyl |
| | | groups |
| clb3 | 2 | cyclin-dependent protein kinase, intrinsic |
| | | regulator activity |
| clb6 | 2 | cyclin-dependent protein kinase, intrinsic |
| | | regulator activity |
| adh2 | 2 | alcohol dehydrogenase activity |
| ino80 | 2 | ATPase activity |
| swi4 | 2 | transcription factor activity |
| smc1 | 2 | AT DNA binding, ATPase activity, |
| | | DNA secondary structure binding, |
| | | double-stranded DNA binding |
| smc3 | 2 | ATPase activity |

We herein provide a theoretical basis for a general approach to estimating large gene networks efficiently. Algorithms following this approach consist of two parts. The first part is a heuristic or empirical method to identify a biologically meaningful subspace of the search space. The second part is the optimal estimation of a gene network within the selected subspace.

We have shown that this approach allows one to estimate meaningful gene networks, and to apply biological knowledge appropriately and effectively, while the computation time does not impose practical limitations for the number of genes.

Since the approach does not depend on a certain score or a certain kind of gene expression data, it is generally applicable. Development of new scores incorporating previous knowledge such as sequence information (23) or structure information (13) is a useful way to further increase the predictive power. Other ways to do the subspace selection heuristically include construction of subspaces around gene networks estimated by heuristics, or averaging the gene expression values for clusters and applying Algorithm 1 to find an optimal gene network for the clusters, which can then be used to find an ordering for the clusters (instead of simply sorting by size as in Step 2 of Algorithm 1.2).

### REFERENCES FOR EXAMPLE 1

1. Chickering, D. M., Learning Bayesian networks is NP-complete, in D. Fisher and H.-J. Lenz, editors, Learning from Data: Artificial Intelligence and Statistics V, Springer-Verlag, 1996.
2. Cho, R. J., Campbell, M. J., Winzeler, E. A., Steinmetz, L., Conway, A., Wodicka, L., Wolfsberg, T. G., Gabrielian, A. E., Landsman, D., Lockhart, D. J., Davis, R. W., A genome-wide transcriptional analysis of the mitotic cell cycle, Molecular Cell, 2: 65-73, 1998.
3. Cooper, G. F., Herskovits, E., A Bayesian method for the induction of probabilistic networks from data. Machine Learning, 9: 309-347, 1992.
4. Friedman, N., Goldszmidt, M., Learning Bayesian networks with local structure, Jordan, M. I. (ed.), Kluwer Academic Publishers, 421-459, 1998.
5. Friedman, N., Linial, M., Nachman, I., Pe'er, D., Using Bayesian networks to analyze expression data, Journal of Computational Biology, 7: 601-620, 2000.
6. Hartemink, A. J., Gifford, D. K., Jaakkola, T. S., Young, R. A., Using graphical models and genomic expression data to statistically validate models of genetic regulatory networks, Pacific Symposium on Biocomputing, World Scientific, 422-433, 2001.
7. Hartemink, A. J., Gifford, D. K., Jaakkola, T. S., Young, R. A., Combining location and expression data for principled discovery of genetic regulatory network models, Pacific Symposium on Biocomputing, World Scientific, 7: 437-449, 2002.
8. de Hoon, M. J. L., Imoto, S., Nolan, J., and Miyano, S., Open source clustering software, Bioinformatics, 2003, in press.
   http://bonsai.ims.u-tokyo.ac.jp/mdehoon/software/cluster/
9. de Hoon, M. J. L., Ott, S., Imoto, S., Miyano, S., Validation of noisy dynamical system models of gene regulation inferred from time-course gene expression data at arbitrary time intervals, European Conference on Computational Biology, 2003.
10. Hartwell, L. H., Hopfield, J. J., Leibler, S., Murray, A. W., From molecular to modular cell biology, Nature, 402: C47-C52, 1999.
11. Imoto, S., Goto, T., Miyano, S., Estimation of genetic networks and functional structures between genes by using Bayesian networks and nonparametric regression, Pacific Symposium on Biocomputing, World Scientific, 175-186, 2002.
12. Imoto, S., Kim, S., Goto, T., Aburatani, S., Tashiro, K., Kuhara, S., Miyano, S., Bayesian network and nonparametric heteroscedastic regression for nonlinear modeling of genetic network, Journal of Bioinformatics and Computational Biology, 1: 231-252, 2003.
13. Nariai, N., Kim, S., Imoto, S., Miyano, S., Using protein-protein interactions for refining gene networks estimated from microarray data by Bayesian networks, Pacific Symposium on Biocomputing, World Scientific, in press, 2004.
14. Ong, I. M., Glasner, J. D., Page, D., Modelling regulatory pathways in E. coli from time series expression profiles, Bioinformatics, 18: 241-248, 2002.
15. Example 2.
16. Pe'er, D., Regev, A., Elidan, G., Friedman, N., Inferring subnetworks from perturbed expression profiles, Bioinformatics, 17: 215-224, 2001.
17. Robinson, R. W., Counting labeled acyclic digraphs, New Directions in the Theory of Graphs, 239-273, 1973.
18. http://www.yeastgenome.org/
19. Shen-Orr, S. S., Milo, R., Mangan, S., Alon, U., Network motifs in the transcriptional regulation network of Escherichia coli, Nature Genetics, 31: 64-68, 2002.
20. Smith, V. A., Jarvis, E. D., Hartenink, A. J., Evaluating functional network inference using simulations of complex biological systems, Bioinformatics, 18: 216-224, 2002.
21. van Someren, E. P., Wessels, L. F. A., Backer, E., Reinders, M. J. T., Genetic network modeling, Pharmacogenomics, 3(4): 507-525, 2002.
22. Sonenshein, A. L., Hoch, J. A., Losick, R., Bacillus subtilis and its closest relatives: from genes to cells, ASM Press, Washington, D.C., 2001.
23. Spellman, P., Sherlock, G., Zhang, M., Iyer, V., Anders, K., Eisen, M., Brown, P., Botstein, D., Futcher, B., Comprehensive identification of cell cycle-regulated genes of the yeast Saccharomyces cerevisiae by microarray hybridization, Molecular Biology of the Cell, 9: 3273-3297, 1998.
24. Tamada, Y., Kim, S., Bannai, H., Imoto, S., Tashiro, K., Kuhara, S., Miyano, S., Estimating gene networks from gene expression data by combining Bayesian network model with promoter element detection, Bioinformatics, 19: 227-236, 2003.
25. Zhu, G., Spellman, P. T., Volpe, T., Brown, P. O., Botstein, D., Davis, T. N., Futcher, B., Two yeast forkhead genes regulate the cell cycle and pseudohyphal growth, Nature, 406: 90-94, 2000.

### Example 2

### Finding Optimal Models for Small Gene Networks

Introduction

Inference of gene networks from gene expression measurements is a major challenge in Systems Biology. If gene networks can be inferred correctly, it can lead to a better understanding of cellular processes, and, therefore, have applications to drug discovery, disease studies, and other areas.

Bayesian networks are a widely used approach to model gene networks (see refs. 3, 4, 7, 9, 11, 13, 14, 17). In Bayesian networks, the behavior of the gene network is modeled as a joint probability distribution for all genes. This allows a very general modeling of gene interactions. The joint probability distribution can be decomposed as a product of conditional probabilities P(X_{g}|X₁, . . . , Xₙ), representing the regulation of a gene g by some genes g₁, . . . , gₙ. This decomposition can be represented as a directed acyclic graph. The Bayesian network model has been shown to allow finding biologically plausible gene networks (see refs. 4, 9).

However, the difficulty of learning Bayesian networks lies in its large search space. The search space for a gene network of n genes is the space of directed acyclic graphs with n vertices. A recursive formula as well as an asymptotic expression for the number of directed acyclic graphs with n vertices (cₙ) was derived by Robinson (see ref. 15). We state the asymptotic expression here:

$${c}_{n} = \frac{n ! \cdot {2}^{\frac{n}{2} \cdot ( n - 1 )}}{r \cdot {z}^{n}} ; r ∼ 0.57436 ; z ∼ 1.4881$$

For example, there are roughly 2.34·10⁷² possible networks with 20 genes, and about 2.71·10¹⁵⁸ possible solutions for a gene network with 30 genes. Even for a gene network of 9 genes (search space size roughly 1.21·10¹⁵), a brute force approach would take years of computation time even on a supercomputer. Moreover, it is known that the problem of finding an optimal network is NP-hard (see ref. 1), even for the discrete scores BDe (see refs. 2, 3) and MDL (see ref. 3). Therefore, researchers have so far used heuristic approaches like simulated annealing (see ref. 8) or greedy algorithms (see ref. 9) to estimate Bayesian networks (see ref. 18).

However, since the accuracy of heuristics is uncertain, it is difficult to base conclusions on heuristically estimated networks. In order to overcome this problem, we have analyzed the structure of the super-exponential search space and developed an algorithm that finds the optimal solution within the super-exponential search space in exponential time. This approach is feasible for gene networks of 20 or more genes, depending on the concrete probability distribution used. Furthermore, adding biologically justified assumptions, the optimal network can be inferred for gene networks of up to 40 genes.

Overcoming the uncertainties of heuristics opens up the possibility to compare statistical models with respect to their power to infer biologically accurate gene networks. Also, this method is a valuable tool for refining gene networks of known functional groups of genes.

Methods are presented in Section 2.2. In Section 2.3 we present results of an application of this method, which show that it can estimate gene networks biologically accurate.

2.2 Methods

2.2.1 Preliminaries

Throughout this section, we assume we are given a set of genes G and a network score function as used by several groups (see refs. 4, 9, 17), i.e. a function s:G×2^{G}→R that assigns a score to a gene \tilde{g}∈G and a set of parent genes A⊂G. Given a network N, the score of N is defined as score(N)=Σ_{g∈G}_{^{S}}(g,P^{N}(g)), where P^{N}(g) denotes the set of g's parents in N.

### EXAMPLES

1. BDe score (see refs. 2, 3)

The score is proportional to the posterior probability of the network, given the data. When the BDe score is used, the microarray data needs to be discretized.
2. MDL score (see ref. 3) The MDL score makes use of the minimal description length principle and also uses discretized data.
3. BNRC score (see ref. 9) The BNRC score uses nonparametric regression to capture nonlinear gene interactions. Since the data does not need to be discretized, no information is lost. The task of inferring a network is to find a set of parent genes for each gene, such that the resulting network is acyclic and the score of the network is minimal.

Below, we introduce some notations needed to describe the algorithm.

Definition 2.1: F

We define F:G×2^{G}→R as F(g,A)=_{def}min_{B⊂A}_{^{S}}(g,B) for all \tilde{g}⊂G and A⊂G.

The meaning of F(g,A) is, by the definition, the optimal choice of parents for gene g, when parents have to be selected from the subset A. For every acyclic graph, there is an ordering of the vertices, such that all edges are oriented in the direction of the ordering. Conversely, when given a fixed order of G, we can think of the set of all graphs that comply with the given order, as we do in the next definition.

An ordering of a set A⊂G can be described as a permutation π:{1, . . . , |A|}→A. Let us use Π^{A} to denote the set of all permutations of A.

Definition 2.2: π-linearity

Let A⊂G and \tilde{π}Π^{A}. Let N⊂A×A be a network. We say N is π-linear iff for all (g,h)∈Nπ⁻¹(g)<π⁻¹(h) holds.

Now we use the above definitions and define function Q^{A}, which will allow us to compute the score of the best π-linear network for a given π, as we show below.

Definition 2.3: Q^{A}

$$\begin{matrix}Let A ⊆ G . We define {Q}^{A} \text{:} {Π}^{A} \to R as & \\ {Q}^{A} ( π ) = def {\sum }_{g ∈ A} F ( g , \{ h ∈ A \vert {π}^{- 1} ( h ) < {π}^{- 1} ( g ) \} ) . \\ for all \tilde{π} {Π}^{A} . & ( 2 )\end{matrix}$$

If we can compute the best π-linear network for a given permutation π using functions F and Q, then what we need to do in order to find the optimal network is to find the optimal permutation π, which yields the global minimum. Formally, we define function M for this step.

Definition 2.4: M

We define M:2^{G}→_{A⊂G}Π^{A} as
M(A)=_{def}min_{π∈Π}_{^{A}}Q^{A}(π)
for all A⊂G.

Algorithm 2.1

Using above notations, algorithm 2.1 can be defined as follows.
Step 1: Compute F(g,φ)=s(g,φ) for all g∈G.
Step 2: For all A⊂G, A≠φ and all g∈G compute F(g, A) as min{s(g,A),min_{a∈A}⁻F(g,A−{a})}.
Step 3: Set M(φ)=φ.
Step 4: For all A⊂G, A≠φ, do the following two steps:
Step 4a: Compute
   g*=arg min_{g⊂A}(F(g,A−{g})+Q^{A-{g}}(M(A−{g}))).
Step 4b: For all 1≦i<|A|, set M(A)(i)=M(A−{g*})(i), and M(A)(|A|)=g*.
Step 5: return Q^{G}(M(G)).

In the recursive formulas given in Step 2 and in Step 4, we want to compute the function F resp. M for a subset A⊂G of cardinality m=|A|, and need function values of function F resp. M for subsets of cardinality m−1. Therefore, we can apply dynamic programming in Step 2 as well as in Step 4 to compute functions F resp. M for subsets A of increasing cardinality. In the recursive formula in Step 4, first the last element g of the permutation M(A) is computed in Step 4a, and then M(A) is set in Step 4b.

Correctness and Time Complexity

The correctness of the recursive formula in Step 2 of algorithm 2.1 follows directly from the definition of F. Therefore, after execution of Step 1 and Step 2, the values of function F for all genes g and all subsets A□G are stored in the memory. Before proceeding to Step 3 and Step 4, we state a lemma on the meaning of function Q^{A}.

Lemma 2.1

Let A⊂G and πΠ^{A}. Let N*⊂A×A be a π-linear network with minimal score. Then, Q^{A}(π)=score(N*) holds.

Proof. In a π-linear graph, a gene g can only have parents h, which are upstream in the order coded by π, that is, π⁻¹(h)<π⁻¹(g). Therefore, when selecting parents for g, we are restricted to B={h∈A|π⁻¹(h)<π⁻¹(g)}, and F(g,B) is the optimal choice in this case. Since in a π-linear graph, all edges comply with the order coded by π, we can choose parents in this way for all genes independently, which proves lemma 2.1.

Using Lemma 2.1, we prove that function M can be computed by the formula given in Step 4.

Lemma 2.2

Let A⊂G. Let g*=arg min_{g∈A}(F(g,A={g})+Q^{A-{g}}(M(A−{g}))).

Define π∈Π^{A} by π(i)=M(A−{g*})(i), and π(|A|)=g.

Then, π=M(A).

Proof. Let π^{-′}∈Π^{A}. By the definition of M, we have to show Q^{A}(π)Q^{A}(π′). Let N* be an optimal π′-linear network, M* be an optimal π′-linear network. Then, by Lemma 2.1, Q^{A}(π)Q^{A}(π′) is equivalent to score N* score M*. Let us denote the last element of π′ as h=π′(|A|). We note that for any B⊂G, Q^{B}(M(B)) is the score of a global optimal network on B by above definitions. Therefore, we have:

$$\begin{matrix}score ( {M}^{*} ) = s ( h , {P}^{{M}^{*}} ( h ) ) + {\sum }_{g ∈ A - \{ h \}} s ( g , {P}^{{M}^{*}} ( g ) ) \geq \\ s ( h , {P}^{{M}^{*}} ( h ) ) + {Q}^{A - \{ h \}} ( M ( A - \{ h \} ) ) \geq \\ F ( h , A - \{ h \} ) + {Q}^{A - \{ h \}} ( M ( A - \{ h \} ) ) \geq \\ {min}_{h ∈ A} F ( h , A - \{ h \} ) + {Q}^{A - \{ h \}} ( M ( A - \{ h \} ) ) \\ = F ( {g}^{*} , A - \{ {g}^{*} \} ) + {Q}^{A - \{ {g}^{*} \}} ( M ( A - \{ {g}^{*} \} ) ) \\ score ( {N}^{*} ) ,\end{matrix}$$

which demonstrates lemma 2.2.

Since Q can be directly computed using F, the algorithm can compute Q^{G}(M(G)) in Step 5. Finally, Q^{G}(M(G)) is the score of an optimal Bayesian network by definition, which shows the correctness.

If the information of the best parents is stored together with F(g,A) for every gene g and every subset A⊂G, the optimal network can be constructed during the computation of Q^{G}(M(G)).

Theorem 2.1 Optimal Network Without Constraints

The algorithm finds the optimal network using O(n·2ⁿ) dynamic programming steps.

Proof. The dynamic programming in Step 1 and Step 2 requires O(n·2ₙ) (n=|G|) steps and in each step one score is computed. In the dynamic programming in Step 3 and Step 4 O(2ⁿ) steps are needed, where each steps involves looking up some previously stored scores. Note that the function Q^{A} does not need to be actually computed in Step 4a, because Q^{A-{g}} can be stored together with M(A−{g}) in previous steps. Therefore, the overall time complexity is O(n·2ⁿ).

In biological reality, while the number of children of a regulatory gene may be very high, the number of parents can be assumed to be limited. When we limit the number of parents, the number of score calculations reduces substantially, allowing the computation of larger networks.

We state the following corollary, which is practically very meaningful (see Section 2.3).

Corollary 2.1 Let ∈IN be a constant. Optimal networks, in which no gene has more than m parents, can be found in O(n·2ⁿ) dynamic programming steps. [quote] If we do not want to limit the number of parents by a constant, but instead can select for each gene a fixed number of candidate parents, the complexity changes as follows.

Corollary 2.2 Let ∈IN be a constant. For each g∈G, let C^{g}⊂G be a set with C^{g}≦m. Optimal networks, in which each gene g has parents only in C_{g}, can be found in O(2ⁿ) dynamic programming steps.

Proof. Since the parents of each gene are selected from a set of constant size, the complexity of the dynamic programming in Step 1 and Step 2 becomes constant. Therefore, the overall complexity becomes O(2ⁿ).

We note, that the two applications of dynamic programming in our algorithm can be implemented as a single application of dynamic programming, because when we compute function M for a set of size m, we only need function values of function F for a set of size m−1. Therefore, only the function values for functions F and M for sets of size m−1 and m need to be stored in the memory at the same time. This is practically meaningful to reduce the required amount of memory.

We also note that the algorithm can be modified to also compute suboptimal solutions. Computing the second-best or the third-best network might be valuable in order to assess the stability of the inferred networks under marginal changes of the score.

Results

Algorithm 2.1 described above was implemented as a C++ program. As scoring functions, existing implementations of the BNRC score, the BDe score and the MDL score are used. All three approaches (Theorem 2.1, Corollary 2.1 and 2.2) were implemented.

We applied the program to a dataset of 173 microarrays, measuring the response of Saccharomyces cerevisiae to various stress conditions. (See ref. 5).

Application to Heat Shock Data

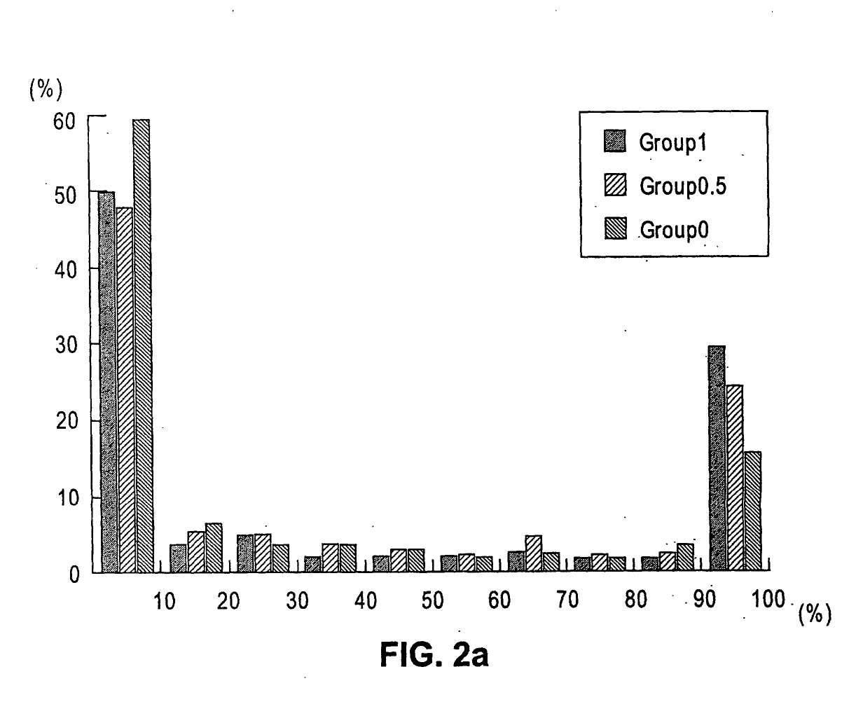

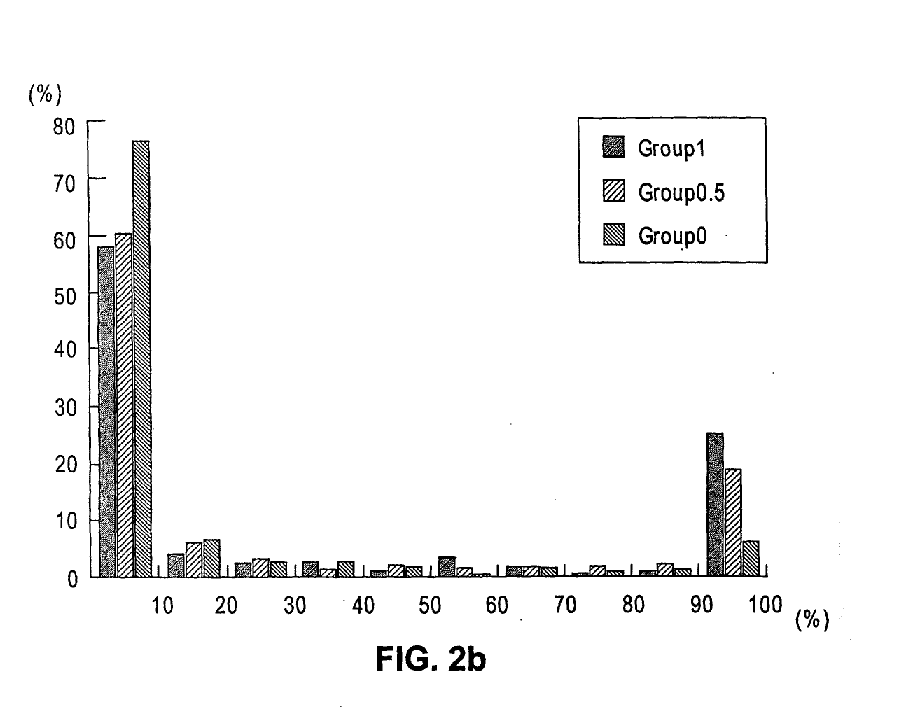

From the dataset we selected 15 microarrays from 25° C. to 37° C. heat shock experiments and 5 microarrays from heat shock experiments from various temperatures to 37° C. Then we selected a set of 9 genes, which are involved or putatively involved in the heat shock response. FIG. 2 shows the optimal network with respect to the BNRC score.

We observe that the transcription factor MCM1 is estimated to regulate three other genes, while it is not regulated by one of the genes in this set, which is plausible. The second transcription factor in our set of genes, HSF1, is estimated to regulate three other heat shock genes. It is also estimated to be regulated by a HSP70-protein (SSA1), which was reported before (see ref. 16). Another chaperone among these genes, SSA3, also seems to play an active role in the heat shock response and interacts with SSA1 and HSP104, coinciding with a report by Glover and Lindquist (see ref. 98).

Table 2.1 depicts results of such analysis. Overall, the result is biologically plausible and gives an indication for the active role of the chaperones SSA1 and SSA3 during the heat shock response. We conclude that optimally inferred gene networks are meaningful and useful for the elucidation of gene regulation.

TABLE 2.1
Genes Involved in Heat Shock Responses

| gene | annotation |
|---|---|
| HSF1 | heat shock transcription factor |
| SSA1 | ER and mitochondrial translocation, cytosolic HSP70 |
| SSA3 | ER and mitochondrial translocation, cytosolic HSP70 |
| HIG1 | heat shock response, heat-induced protein |
| HSP104 | heat shock response, thermotolerance heat shock protein |
| MCM1 | transcription, multifunctional regulator |
| HSP82 | protein folding, HSP90 homolog |
| YRO2 | unknown, putative heat shock protein |
| HSP26 | diauxic shift, stress-induced protein |

Computational Possibilities and Limitations

While even networks of small scale like the network inferred in Section 2.3.1 cannot be inferred with a brute force approach (Equation 1), they can be optimally inferred by our program using a single Pentium CPU operating at 1.9 GHz for about 10 minutes. In order to evaluate the practical possibilities of this approach, we selected 20 genes with known active role in gene regulation (see ref. 12) from the data set and estimated a network with optimal BNRC score using all 173 microarrays. The computation finished within about 50 hours using a Sun Fire 15K supercomputer with 96 CPUs, 900 MHz each. As a result of this computational experiment, we conclude that our method is feasible for gene networks of 20 genes, even if no constraints are made and a complex scoring scheme like the BNRC score is used. For the discrete scores BDe and MDL, which can be computed much faster, even networks of more than 20 genes can be inferred optimally without constraints.

When the number of parents is limited to about 6 (Corollary 2.1) or, alternatively, sets of about 20 candidate parents are preselected (Corollary 2.2), even with the BNRC score gene networks of more than 30 genes can be inferred optimally. However, the method as it is now will not allow one to estimate networks of more than about 40 genes.

While the theoretical time complexity of the approach given in Corollary 2.2 is below the time complexity of the approach given in Corollary 2.1, we argue that the latter might be practically more important. First, limiting the number of parents by a constant can be easily done and is biologically justified, while selecting a set of candidate parents for each gene requires a method of gene selection, which can potentially bias the computation result. Second, it has to be considered that each dynamic programming step in the computation of function F requires the computation of one score, while one dynamic programing step for function M only requires looking up some previous results. When the number of parents is limited as in Corollary 2.1, the required number of score calculations becomes a polynomial, which makes this approach faster in practical applications, though the approach in Corollary 2.2 is theoretically superior.

We have presented a method that allows to infer gene networks of 20-40 genes optimally, depending on the probability distribution used and on whether additional assumptions are made or not. This makes it possible to compare different scoring schemes, to assess the best parameters for a given scoring scheme, and to evaluate the usefulness of given microarray data, since optimal solutions are obtained. Also, the method is especially useful in settings where researchers focus on a certain group of genes and want to exploit gene expression measurements concerning these genes to the full extent.

In contrast to heuristic approaches, if the results are unsatisfying or contradictory to biological knowledge, it can be concluded that the statistical model is incorrect or the data is insufficient. Even for a network of 20 genes, getting to know the best network from the huge search space given is a large amount of information.

We note that the method is not dependent on a certain scoring scheme or a certain kind of gene expression measurements. It can be applied in any setting, where a score as defined in Section 2.2 is given. For example, when sequence information (see ref. 19), protein interaction data (see ref. 10), or other knowledge is incorporated in the score function, this method can also be applied.

In order to find gene networks with more than 40 genes, two directions can be used. First, if a part of the set of subsets, in which the algorithm performs the actual search, can be pruned, the limit of feasibility might be increased. Second, compartmentalization of gene networks (see ref. 18) might be used to decompose larger networks in smaller parts, and infer each partial network optimally.

### REFERENCES

1. D. M. Chickering. Learning Bayesian networks is NP-complete. In D. Fisher and H.-J. Lenz, editors, Learning from Data: Artificial Intelligence and Statistics V, Springer-Verlag, 1996.
2. G. F. Cooper, E. Herskovits. A Bayesian method for the induction of probabilistic networks from data. Machine Learning, 9: 309-347, 1992.
3. N. Friedman, M. Goldszmidt. Learning Bayesian networks with local structure. Jordan, M. I. (ed.), Kluwer Academic Publishers, pp. 421-459, 1998.
4. N. Friedman, M. Linial, I. Nachman, D. Pe'er. Using Bayesian networks to analyze expression data. Journal of Computational Biology, 7: 601-620, 2000.
5. A. P. Gasch, et. al. Genomic expression programs in the response of yeast cells to environmental changes. Molecular Biology of the Cell, 11: 4241-4257, 2000.
6. J. R. Glover, S. Lindquist. Hsp104, Hsp70, and Hsp40: a novel chaperone system that rescues previously aggregated proteins. Cell, 94: 73-82, 1998.
7. A. J. Hartemink, D. K. Gifford, T. S. Jaakkola, R. A. Young. Using graphical models and genomic expression data to statistically validate models of genetic regulatory networks. Pacific Symposium on Biocomputing, 6: 422-433, 2001.
8. A. J. Hartemink, D. K. Gifford, T. S. Jaakkola, R. A. Young. Combining location and expression data for principled discovery of genetic regulatory network models. Pacific Symposium on Biocomputing, 7: 437-449, 2002.
9. S. Imoto, T. Goto, S. Miyano. Estimation of genetic networks and functional structures between genes by using Bayesian networks and nonparametric regression. Pacific Symposium on Biocomputing, 7: 175-186, 2002.
10. T. Ito, T. Chiba, R. Ozawa, M. Yoshida, M. Hattori, Y. Sakaki. A comprehensive two-hybrid analysis to explore the yeast protein interactome. Proceedings of the National Academy of Sciences USA, 97: 4569-4574, 2001.
11. S. Imoto, S. Kim, T. Goto, S. Aburatani, K. Tashiro, S. Kuhara, S. Miyano. Bayesian network and nonparametric heteroscedastic regression for nonlinear modeling of genetic network. Journal of Bioinformatics and Computational Biology, in press, 2003; U.S. patent application Ser. No: 10/259,723.
12. T. I. Lee, N. J. Rinaldi, F. Robert, et. al. Transcriptional regulatory networks in Saccharomyces cerevisiae. Science, 298: 799-804, 2002.
13. I. M. Ong, J. D. Glasner, D. Page. Modelling regulatory pathways in E. coli from time series expression profiles. Bioinformatics, 18: 241-248, 2002.
14. D. Pe'er, A. Regev, G. Elidan, N. Friedman. Inferring subnetworks from perturbed expression profiles. Bioinformatics, 17: 215-224, 2001.
15. R. W. Robinson. Counting labeled acyclic digraphs. New Directions in the Theory of Graphs, pp. 239-273, 1973.
16. Y. Shi, D. D. Mosser, R. I. Morimoto. Molecular chaperones as HSF1-specific transcriptional repressors. Genes & Development, 12: 654-666, 1998.
17. V. A. Smith, E. D. Jarvis, A. J. Hartemink. Evaluating functional network inference using simulations of complex biological systems. Bioinformatics, 18: 216-224, 2002.
18. E. P. van Someren, L. F. A. Wessels, E. Backer, M. J. T. Reinders. Genetic network modeling. Pharmacogenomics, 3(4): 507-525, 2002.
19. Y. Tamada, S. Kim, H. Bannai, S. Imoto, K. Tashiro, S. Kuhara, S. Miyano. Estimating gene networks from gene expression data by combining Bayesian network model with promoter element detection. Bioinformatics, in press, 2003.

### Example 3

### Gene Networks that are Better than Optimal

3.1 Introduction

The estimation of gene networks from expression level measurements is one focus of Bioinformatics research in recent years (1, 5, 8, 13, 31). Learning the structure of gene networks from expression data may deepen our understanding of the responses of cells to their environment and our knowledge about construction principles of gene networks (10, 29), with possible applications in several disciplines.

A widely used approach to model gene networks are Bayesian networks 3, 4, 9, 13, 15, 26, 30), which model the expression level of a gene as random variables and gene networks as joint probability distributions. These distributions are decomposed using directed acyclic graphs, which we will call networks. Networks are scored using score functions based on the likelihood of networks, given the data.

A recent result shows that one can get to know optimal gene network models with respect to some data for gene networks of about 30 genes or less (25). This result holds for any score function s:G×2^{G} assigning a score to a gene g and a set of parents for g. However, while optimal gene network models are the most likely models, there may still be very different models that have approximately the same likelihood with respect to some data, especially since gene expression measurements will in general provide only partial information about the gene network. Furthermore, even for a gene network of only 10 genes, there are about 4.17*10¹⁸ possible network models (17). Therefore, even optimal gene network models will in general not match the target gene network.

Our endeavor to tackle this problem is threefold. First, we provide the theoretical basis and an algorithm for the enumeration of optimal and suboptimal networks in the order of their likelihood. Second, we rigorously compare optimal gene network models to the available knowledge about existing gene networks. Third, we present an approach to extract the reliable part of optimal gene network models and apply this approach to the available data of B. subtilis and E. coli in order to compare gene network models of related species.

Our results show that the partial networks identified by our approach are in significantly better agreement with the knowledge than an optimal network model itself Since we base our approach on the best n gene network models, one can derive conclusions from these estimations more reliably than from methods that rely on heuristics.

After presenting our theoretical results in Section 3.2, we state and discuss results of the comparison of estimations and knowledge in Section 3.3. Then, we present our gene network estimation approach in Section 3.4, which we evaluate and apply in Section 3.5.

3.2 Gene Network Estimation and Enumeration

Throughout the Example, we assume we are given a set of genes G and a score function s:G×2^{G}→IR assigning a score to a gene g and a set of parents for g. Given a network N, the score of N is defined as score(N)=Σ_{g0G}_{^{S}}(g,P^{N}(g)), where P^{N}(g) denotes the set of g's parents in N. In order to find the joint probability distribution that explains given data best, we need to find the directed acyclic graph N that minimizes score(N).

Since this optimization problem is NP-hard (2), and the search space has super-exponential size (27), researchers have frequently applied heuristic approaches like greedy algorithms, simulated annealing, or genetic algorithms (5, 13, 31). However, recently the following result was derived, which leads to an algorithm that can estimate gene networks of about 20 genes without constraints, and networks with 30 or little more genes, when making use of the fact that genes in real gene networks have a limited number of parents.

Theorem 3.1 (25)

Optimal networks can be found using O(n·2ⁿ) dynamic programming steps.

For larger gene networks, empiric or heuristic methods can be used to select a subspace of the search space. If this is done as described in (24), the algorithm of (25), can be used to find optimal solutions within the selected subspace, yielding a combined approach of deterministic and heuristic techniques.

However, different networks may yield the same expression data with equal or approximately equal probability. Therefore, one may not assume that given data contains the complete information about a gene network, but one has to bear in mind that the information that can be derived from a given dataset might be very well partial information. Thus, even if an optimal network is found, it will in general contain wrong edges. In order to overcome this problem, we have extended the algorithm of (25) and proved the following result.

Theorem 3.2

Let m0IN. The best m networks can be found using O(n·2ⁿ) dynamic programming steps.

3.2.1 Proof—Enumerating Optimal Gene Networks

3.2.1.1 Algorithm 3.1

We herein show how to extend the algorithm from (25) in order to allow the enumeration of optimal and suboptimal networks. We first define some functions, and then show how these functions can be computed for gene networks of considerable size. As in Section 3.2, we assume we are given a set of genes G and a score function s:G×2^{G}!IR. Given a network N, the score of N is defined as score(N)=3_{g0G}_{^{S}}(g,P^{N}(g)), where P^{N}(g) where P^{N}(g) denotes the set of g's parents in N. Throughout this section, we assume networks with equal score to be sorted in some way, therefore allowing the notion “the n-th best network”.

Definition 3.1: F^{m}

Let m∈IN. We define F^{m}:G×2^{G}×I→→2^{G} inductively. First, for all g∈G and A⊂G, we define
F^{m}(g, A, n)=_{def}arg min s(g,B).
B⊂A (2)
Then, denoting the set of all previous solutions {F^{m}(g, A, p)|p<n} as J(n),
F^{m}(g, A, n)=_{def}arg min s(g,B)
B⊂A (3)
B∈J(n)
for all 1<n≦m.

Definition 3.2: S^{m}

Let m0IN. We define S^{m}: G×2^{G}×IN_{≦m}→IR as
S^{m}(g, A, n)=_{def}s(F^{m}(g, A, n)) (4)
for all g∈G, A⊂G, and n∈IN_{≦m}.
∈⊂∈

By the definition, F^{m}(g,A,n) is the n-th best choice of parents for a gene g when the parents have to be selected from A, and S^{m}(g,A,n) is the score for this choice. When m is clear from the context, we use F and S instead of F^{m} and S^{m}, respectively. Note that F^{m} and S^{m} are partially defined functions, since m may be larger than the number of subsets of A.

An ordering of a set AfG can be described as a permutation B:{1, . . . , |A|→A. Let us use Π^{A} to denote the set of all permutations of A. We need the following notation, which denotes the networks in which all edges comply with the direction given by a permutation π.

Definition 3.3: π-linearity

Let A⊂G and π∈Π^{A}. Let N⊂A×A be a network. We say N is π-linear iff for all (g,h)∈Nπ⁻¹(g)<π⁻¹(h) holds.

The basic strategy of our algorithm is to divide the space of all directed acyclic graphs on a set A⊂G in subsets of π-linear networks, for all π∈Π^{A}, decomposing the problem of finding optimal and suboptimal networks to the following two problems:

1. Find the subset of the search space that contains the (sub-)optimal network searched for. (Lemma 2)

2. Find the (sub-)optimal network within the selected subspace.

(Lemma 1 and Lemma 2)

We will use π to denote a subspace of the search space. In order to find optimal and suboptimal networks for a given permutation π, we need the following function Q^{A}. For a given gene g, we denote the set of all genes that precede g in π as V(π, g)=def{h|π⁻¹(h)<π⁻¹(g)}.

Definition 3.4:

Let A⊂G. We define as Q^{A}:Π^{A}×IN^{|A|}→2^{A×A} as
Q^{A}(π,v)=_{def}{(h,g)|h∈F(g,V(π,g), v_{π-1,(g)},} (5)
for all π∈Π^{A}.

In Definition 4, we have used a vector v∈IN^{|A|} to determine the rank of the selection of parents for the particular genes. In Lemma 1 and Lemma 2, it will be shown that Q^{A}(π,v) is an optimal or suboptimal π-linear network, it's rank depending on v. Next, we define two functions M^{m} and D^{m} that specify subspaces, in which (sub-)optimal networks can be found, and the choice of a network from the subspace, respectively.

Definition 3.5: M^{m}, D^{m}

$$Let m ∈ IN . W e define {M}^{m} \text{:} {2}^{G} \times {IN}_{\leq m} \to {⋃}_{A ⊆ G} {Π}^{A} and {D}^{m} : {2}^{G} \times {IN}_{\leq m} \to ⋃ \frac{\vert G \vert}{i = 0} {IN}^{i}$$

inductively over their second parameter. Let A⊂G. First, we define
D^{m}(A,1)=_{def}(1, . . . , 1)∈IN^{|A|} (6)
and
M^{m}(A,1)=_{def}arg min score(Q^{A}(π,D^{m}(A,1))) (7)
π∈Π^{A}
Let π∈IN_{≦m} with n>1 and let N be a network on A with optimal score among networks not in {Q^{A}(M^{m}(A,p), DM(A,p))|p<n}. Let π*∈Π^{A} be a permutation such that N is π*-linear. We define
M^{m}(A,n)=_{def}π* (8)
Let v*∈IN^{|A|} such that for every g∈A, the set of g's parents, P^{N}(g), equals
F^{m}(g,V,(π*,g),v*_{π*-1(g)}).⁵ (9)
We define:
D^{m}(A,n)=_{def}v* (10)

As F^{m} and S^{m}, M^{m} and D^{m} are partial functions. In Table 3.4, we summarize above notations. Using these notations, our algorithm can be defined as flows, given m0IN:

TABLE 3.1
Functions Used to Define the Algorithm.
The meanings follow directly from the definitions and Lemma 3.1.

| Function | Functionality | Meaning |
|---|---|---|
| F^{m} | $G \times {2}^{G} \times {IN}_{sm} -> {2}^{G}$ | F^{m}(g,A,n) is the n -th best choice of parents for g from A |
| Q^{A} | ${}^{\prod A} \times {IN}^{\vert A \vert} {->}^{A \times A}$ | Q⁴(π,v) is a π-linear network |
| M^{m} | ${2}^{G} \times {IN}_{sm} -> {⋃}_{A ⋐ G} {\prod }^{A}$ | the n -th best network on A is M^{m}(A,n) -linear |
| D^{m} | ${2}^{G} \times {IN}_{sm} -> ⋃ \frac{\vert G \vert}{i = 0} {IN}^{i}$ | the n -th best network on A is Q^{A}(M^{m}(A,n),D^{m}(A,n)) |

Using these notations, Algorithm 3.1 can be defined as follows.

| | |
|---|---|
| Step 1: | Set F^{m}(g,ø,1) = ø, S^{m}(g,ø,1) = s(g,ø) for all g ∈ G. |
| Step 2: | For all g ∈ G, all A⊂G, A ≠ N and all n≦m do the following |
| | two steps: |
| Step 2a: | Select B*⊂A from |
| | {B⊂A\B = A v B = F^{m}(g,A−{h},p),h ∈ A,p≦m} − |
| | {F^{m}(g,A,p)\|p<n} such that s(g,B*) is minimized. |
| Step 2b: | Set F^{m}(g,A,n)=B*, S^{m}(g,A,n=s(g,B*). |
| Step 3: | Set M^{m}(ø,1)=ø and D^{m}(ø,1)=ø. |
| Step 4: | For all A⊂G, ø, and all n≦m do the following three steps: |
| Step 4a: | Choose a triple (g,p,q) ∈A × IN_{≦m} × IN_{≦m} such that |
| | score(Q^{A-{g}}(M^{m}(A−{g},p)D^{m}(A−{g},p)))+S^{m}(g,A−{g},q) |
| | is minimized and (g,p,q) induces a network different |
| | from Q^{A}(M^{m}(A,r),D^{m}(A,r)) for r<n. |
| Step 4b: | Set M^{m}(A,n)(i)=M^{m}(A−{g},p)(i) for i< \|A\|, |
| | and M^{m}(A,n) (\|A\|) = g,. |
| Step 4c: | Let v denote D^{m}(A−{g},p). Set w ∈ IN^{\|A\|}as wᵢ=vᵢ for all |
| | I <\|A\|and ^{w}\|A\|= q. |
| | Set D^{m}(A,n) = w. |
| Step 5: | Return Q^{G}(M^{m}(G,i),D^{m}(G,i)) for all i≦m. |

Algorithm 3.1 computes the functions F^{m} and S^{m} in Step 1 and in Step 2 for all g∈G, A⊂G, and n≦m. In order to select B^{?} in Step 2a, only function values of F^{m} for a set A of lower cardinality or lower n are needed. Therefore F^{m} and S^{m} can be computed applying dynamic programming.

In Step 3 and Step 4, functions M^{m} and D^{m} can be computed similarly using dynamic programming, since for the selection of a triple in Step 4a only function values of M^{m} and D^{m} for a set A of lower cardinality or n of lower cardinality are needed in order to compute M^{m}(A,n) and D^{m}(A,n). The meaning of the triple (g,p,q) is as follows. g is a candidate for the last element in the permutation searched for. When g becomes the last element, the remaining permutation can be chosen from up to m previously computed permutations of A−{g}. The remaining permutation chosen is specified by p. Then, to form a network in the subspace defined by the resulting permutation, the q-th best selection of parents for g is used, while for the other genes parents are selected as indicated by D^{m}(A−{g},p).

Since all four functions F^{m}, S^{m}, M^{m}, and D^{m} are partially defined, not for all n function values can be calculated for sets A of low cardinality. For simplicity, we did not explicitly mention this in the formulation of the algorithm.

Algorithm 3.1, as stated above, computes a fixed number (m) of solutions, regardless of the size of the set A. In practical applications, the computation time can be optimized by calculating a fewer number of (sub-)optimal solutions for layers l with a large number of subsets of G with l elements. Then, when the number of subsets declines for high cardinality of A, m can be increased. There is no guarantee that more than m (sub-)optimal solutions can be derived when only m optimal solutions are known for lower layers, but this worked in test computations.

Since the number of networks that have to be stored during the computations can get very large, it is important to store networks efficiently in memory, while allowing fast decoding of stored networks. In our implementation, based on the formulation above, we store permutations π and make use of the restrictions for edges in π-linear networks, yielding a memory- and time-efficient coding of networks.

In order to fulfill the requirement of Step 4a that the chosen network is different from networks chosen previously, networks have to be compared during dynamic programming steps. However, since networks with different scores are different, only networks with equal score need to be compared. Therefore, the number of network comparisons can be minimized in practical applications.

When one layer of F^{m}, M^{m}, or D^{m} is computed, this can be done in an arbitrary order for the sets in the layer, and the computation depends only on values in the lower layer. Therefore, the above algorithm is well parallelizable.

3.2.3 Correctness and Complexity

Let us denote the n-th best network on a set A⊂G by N*_{A,n}. We first state two reformulated lemmata from (25).

Lemma 3.1 Let A⊂G and π∈Π^{A}. Let N*⊂A×A be a π-linear network with minimal score. Then, Q^{A}(π,(1, . . . , 1))=score(N*) holds.

Lemma 3.2 Let A⊂G and m∈IN. Let g*=arg min_{g∈A}(Sm(g,A={g},1)+N*_{A-{g},n}). Define π∈Π^{A} by π(i)=M(A−{g*},1)(i), and π|A|=g*. Then, π=M^{m}(A,1).

Using these, we can prove the correctness of the algorithm defined above.

Theorem 3.2 Let m∈IN

The best m networks can be found using O(n·2ⁿ) dynamic programming steps.

Proof. The output of the algorithm, Q^{G}(M^{m}(G,i),D^{m}(G,i)), i≦m, are the best m networks on G by the definitions. We only need to prove that the recursive formulas given in the algorithm are correct. The equation given in Step 1 are correct by the definition of F^{m} and S^{m}. When we select a subset of a set A?G in Step 2, we have basically two choices: the whole set A or a true subset. In the former case, we can compute the score of the choice directly, in the latter, we can use previously computed values of F^{m} and S^{m}, which gives the correctness of Step 2.

After the execution of Step 2, we have all values of F^{m} and S^{m} computed. Using these values, function Q can be computed directly. Therefore, we only need to compute functions M^{m} and D^{m} in order to produce the output in Step 5. The equations in Step 3 are again correct by the definitions. We observe that with Lemma 3.1 in combination with Definition 3.5, the following equation holds:
N*_{a,n}=QA(M^{m}(A,n),D^{m}(A,n))

From this equation and Lemma 3.2 we see that the recursion in Step 4 is correct for n=1. For n>1, we compute the suboptimal permutation M^{m}(A,n) and the suboptimal choice of parents D^{m}(A,n) in the same way, restricting to a network not previously chosen.

The time required for one dynamic programming step depends on m, but can be regarded as constant for m as chosen in the computations of this work. Furthermore, using a programming technique described in the Appendix, in practical computations it is sufficient to compute significantly less than m networks in most dynamic programming steps.

Using this algorithm, we can enumerate optimal and suboptimal networks in the order of their likelihood. When we can find common components of such networks, the likelihood of the common components is the sum of the likelihood of the networks containing it. Therefore, common components of enumerated networks, called gene network motifs in this work, Therefore, our definition of a gene network motif is, at first, different from the notion used, for example, in (21), but might turn out to be closely related. Therefore, network motif analysis is expected to be more reliable than single network estimations.

3.3. Evaluating the Reliability of Gene Network Estimations

In order to validate that enumerated optimal and suboptimal gene network models contain valuable information about real gene networks, we implemented the algorithm and applied it to RNA microarray data. Considering the close relationship of transcription and translation in bacteria, we expect gene network estimations based on RNA data solely to be more suitable for bacteria than for eukaryotes, in which transcription and translation take place at different places and at a different time. Therefore, we chose Bacillus subtilis and Escherichia coli as targets, for which microarray data as well as knowledge about the gene networks is available.

3.3.1 Data and Software

For E. coli, we selected the datasets GDS95-GDS100 from the Gene Expression Omnibus (35). Changes in gene expression levels were elicited by perturbations of tryptophan metabolism, UV exposure, and novobiocin treatment (17, 18, 19). We then received data concerning known transcriptional regulation in E. coli from RegulonDB (28) for comparison with estimation results.

For B. subtilis, we used several datasets including 70 microarrays from time course experiments under various treatments, and 99 microarrays from gene disruptant experiments. The data is not yet publicly available, though it is was confirmed that biologically meaningful estimations can be done using these data (12). We then received a dataset of known transcriptional regulation from DBTBS (16, 20).

Among the score functions (s:G×2^{G}→IR) used by our implementation, which include the MDL score (4), the BDe score (3, 4), and the BNRC score (13), we selected the BNRC score for the computations in this work for the following reasons. First, the BNRC score uses the data without discretization, avoiding additional parameters and loss of information. Second, gene interactions are modeled using B-splines, allowing for a general modeling not restricted to linear relationships. Third, in preliminary computational experiments using all three score functions on the B. subtilis dataset, the estimations using the BNRC score were in significantly better agreement with textbook knowledge (32).

3.3.2 Selection of Target Networks

From the dataset of known regulatory relations for E. coli, we selected all relations for which experimental evidence is provided. This yielded a set of 899 known relations. From the B. subtilis dataset, we selected 840 regulatory relations with evidence in the literature. In order to select parts of these large networks, we applied a random procedure. Since we need to select genes in a way that there are some known regulatory relations among the selected genes, we select the first few genes randomly, and then select genes that are connected to the previously selected genes iteratively, expanding the selected partial network in each step by one gene and at least one edge. In each iteration we selected a connected component of the partial network with equal probability, and then selected a gene with a known relation to at least one gene in the component randomly, if such a gene exists. Since we should avoid trivial choices of target networks, we chose a gene not connected to the previously selected genes, when five connected genes have been selected in a row.

The selection procedure yielded a known gene network N with non-trivial structure. We represented N as a matrix. Each pair of genes with a known relationship is represented with a 1 entry in the matrix. Pairs of genes with no knowledge are represented by a 0 entry for most pairs, but a 0.5 entry for pairs (g,h), for which one or more of the following four conditions hold.
1. g is regulated by h
2. There is a gene i in the target network that regulates g and h
3. There is a gene i in the target network that is regulated by g(h) and regulates h(g)
4. Condition 2 or condition 3 hold for a gene i outside the target network

Using these conditions, nearly correct predictions were distinguished from wrong predictions. If edge (g,h) is predicted, and (h,g) is a known regulatory relation, then at least the fact that these two genes interact, was correctly predicted. In the same way, indirect regulatory relations, possibly via some gene not included in the target network itself is also not entirely wrong, if predicted.

3.3.3 Evaluation Results

We randomly selected 30 sets of 10 genes as described in Section 3.3.2, and applied the method to each target network. Then we counted how many times each relation was estimated in the best 500 network structures and examined the relationship between the frequencies of estimations and biological knowledge. Note that the resulting networks of our method are directed. However, as we mentioned in the previous section, estimated edges with wrong orientations still have information. So we considered both directed and undirected cases.

It is difficult to know whether each estimated edge is correct or not, because there may be still undiscovered relations. Furthermore, known gene relations may not be expressed in the data. Therefore, we categorized the estimated edges into three groups based on the database information (1, 0.5 and 0) and examined the difference of them. We presumed that good estimations can separate these groups well.

FIGS. 2(a) and 2(b) show the results of B. subtilis time course and disruptant data, respectively. The x-axis shows the percentage of appearances of each edge in 500 networks. The y-axis shows the fraction of edges of the corresponding groups, that fall into the interval. Since we observed two peaks at both ends of the x-axis, we examined these two regions closer.

TABLE 3.2
Frequencies of Edges Around 0 to 10% and 90 to 100%

| | | 0-10% | | | | 90-100% | |
|---|---|---|---|---|---|---|---|
| | | 1 | 0.5 | 0 | 1 | 0.5 | 0 |
| time | Undirected | 49.8 | 48.1 | 59.4 | 29.3 | 24.0 | 15.6 |
| course | directed | 68.7 | 66.0 | 74.6 | 7.72 | 7.27 | 4.47 |
| disruptant | undirected | 57.9 | 60.4 | 76.3 | 24.7 | 18.7 | 5.92 |
| | directed | 73.6 | 76.6 | 87.3 | 10.2 | 7.07 | 2.14 |

Table 3.2 shows the percentages of frequencies. From Table 3.2 we observed the tendencies of three groups. Around 0%, group 0 showed more than 10% higher frequencies than the others. On the contrary, around 100%, the frequencies dropped to the lowest values. On the other hand, group 0.5 indicated closer values to group 1. Comparing time course and disruptant data, the groups were well distinguished while using disruptant data.

TABLE 3.3
Frequencies of Edges Around 0 to 10% and 90 to 100%

| | 0-10% | | | | 90-100% | |
|---|---|---|---|---|---|---|
| | 1 | 0.5 | 0 | 1 | 0.5 | 0 |
| undirected | 60.0 | 51.7 | 63.3 | 17.8 | 24.8 | 13.7 |
| directed | 72.0 | 74.2 | 79.1 | 7.11 | 7.90 | 5.54 |

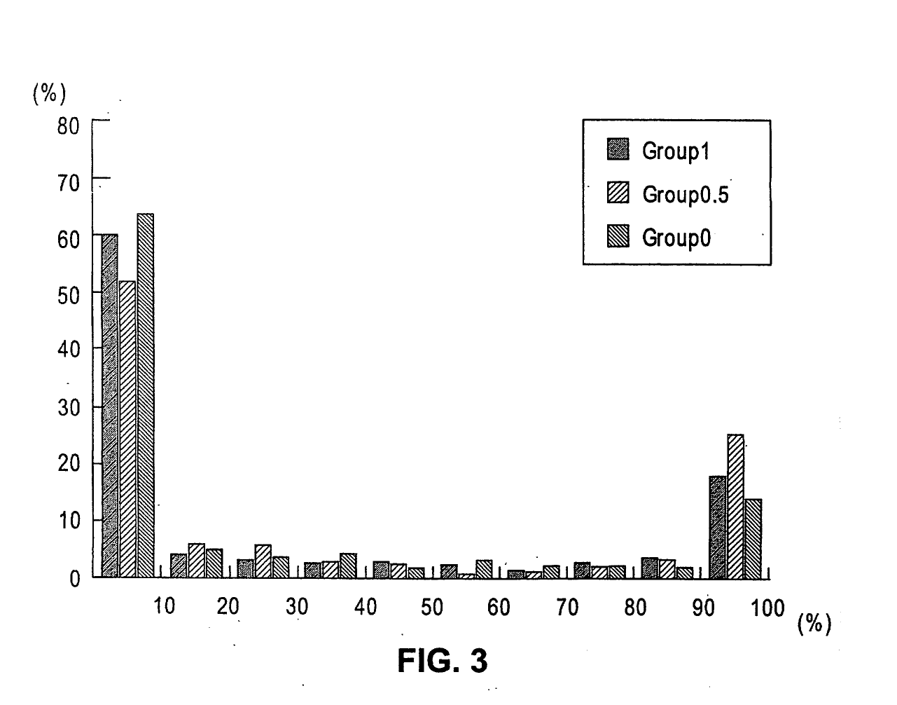

Finally we analyzed E. coli microarray data and the result is shown in FIG. 3 and Table 3.3. Interestingly, the differences between the groups are somewhat small in this result. We presumed that the proposed method can evaluate not only the goodness of scoring function but also the accuracy of data.

3.4 Extraction of Gene Network Motifs

While the evaluation in the previous section was based on counts of edges solely, we now consider using the complete information of enumerated networks.

3.4.1 Motif Extraction Problem

Theorem 3.2 in combination with the techniques described in this Example shows the possibility to enumerate optimal and suboptimal networks for gene networks of considerable size. A straightforward approach to exploit the information given by enumerated networks would be to count the number of occurrences of each edge in the networks, select only the edges, which have a count above some threshold, and compose a partial network from these edges. This approach was used in (26) in order to extract partial networks from networks enumerated by the bootstrap method. Under the assumption that the confidence levels of edges are independent from each other, it was shown that regions of significantly many edges with high confidence levels can be found in gene network estimations. However, this assumption does not account for the fact that the confidence levels of all edges connected to the same gene g depend on the expression measurements of g.

However, even if each single edge has a count above some threshold, the partial network composed from these edges does not necessarily have to be frequent in the networks at hand. Therefore, a partial network composed from likely edges may be unlikely itself This leads to the following problem, which we refer to as the gene network motif extraction problem:
Given graphs N₁=(G,E₁), . . . , Nₘ=(G,Eₘ), and k∈IR, find a set M⊂G×G with |M|=k maximizing the number of graphs Nᵢ which include M, i.e. M⊂Eᵢ.

The motif extraction problem is equivalent to the well-known problem of finding maximal frequent item sets from data mining. The problem of finding balanced complete bipartite subgraphs (6) can be reduced to both problems, which are therefore NP-hard. However, the problem can be solved for practical instances using the exhaustive search strategy we describe in the following.

3.4.2 Motif Extraction Algorithm (Algorithm 3.2)

In order to extract the partial information about gene networks contained in given gene expression measurements, we propose the following strategy, which uses three parameters n, c, k, ∈, IN.

| | |
|---|---|
| Step 1: | Enumerate the most likely gene network models Nᵢ, 1≦i≦n. |
| | (Theorem 2, Appendix) |
| Step 2: | For every g, h ∈0G, count the occurences of the edge (g,h) |
| | in the networks Nᵢ. |
| Step 3: | Select all edges (g,h) with at least c occurences. |
| Step 4: | For all subsets M of the set of selected edges with \|M\| = k, |
| | count the networks including all edges in M. |
| Step 5: | Return all motives M with at least c occurences. |

This algorithm makes use of the fact that every edge in a motif M with at least c occurrences must have at least c occurrences itself. Therefore, the number of candidate edges for composing motifs with more than c occurrences can be essentially reduced in practice. The running time of this exhaustive search strategy gets infeasible when the threshold c is set too low, but this did not impose practical limitations for our computations, since we are interested in gene network motifs with high confidence.

3.5. Motif Extraction Results

As in Section 3, we chose bacteria as a promising target for our estimations. We first evaluate the reliability of motif extractions, then we apply the method to a group of genes that is involved in tryptophan metabolism in B. subtilis as well as in E. coli.

3.5.1 Finding Motifs in Bacterial Gene Networks

In order to evaluate the predictive strength of the motif extraction algorithm, and to compare it to the predictive strength using the most likely gene network model alone, we applied it to the disruptant dataset for B. subtilis. We selected 25 target gene networks Nᵢ of 8 genes in a random way as described in Section 3.3, enumerated the most likely 100 networks, and extracted motifs with 2 or more edges, using 90 as the threshold (parameter c in our algorithm). This computation was performed using a single CPU with 1.9 GHz for about 3 hours. We note that the enumeration can be applied to gene networks of up to about 30 genes, if a supercomputer is used.

We then selected randomly one edge of the optimal network model, and one edge of the motif with the highest score among the motifs with the most edges. We then checked the correctness of both edges, using the DBTBS data, and computed the probability pᵢ of randomly guessing a single edge from the known network correctly by dividing the number of edges with a known regulatory relationship by the total number of possible edges in Nᵢ. According to the results of Section 3, we judged 1-entries and 0.5-entries as correct. We computed an upper bound for the probability of guessing at least k single edges correctly among n networks, P(n,k), by using the following inequality

$$P ( n , k ) \leq {\sum }_{i = k}^{n} ( \frac{n}{i} ) {{p}^{i} ( 1 - p )}^{n - i} , \qquad ( 1 )$$

where p denotes max ᵢ₌₁²⁰pᵢ. The result of this computation is given in Table 3.3. We observed that the results for the motif extraction approach are more strongly significant than the results for optimal gene networks in the case of directed motifs, and equally significant in the case of indirected motifs.

This is due to the fact that while in no case the optimal network model was the empty graph, for some target networks there was no motif above the threshold. Since our random selection of target networks is likely to choose some networks, that are not expressed in the data, we can not expect to find high scoring motifs for any set of genes, therefore predicting regulatory relations might be not appropriate for some target networks. We note that our results also hold for the predictions as a whole, since we selected arbitrary edges for the evaluation.

TABLE 3.3
Evaluation Result for the Motif Extraction Algorithm

| | Number of | | |
|---|---|---|---|
| | Selected | | |
| Method | Edges | Correct Edges | p-value |
| directed edge from | 22 | 15 | 0.00578 |
| directed motif | | | |
| undirected edge from | 22 | 15 | 0.00578 |
| directed motif | | | |
| undirected edge from | 25 | 16 | 0.01083 |
| undirected motif | | | |
| directed edge from | 25 | 16 | 0.01083 |
| optimal network | | | |
| undirected edge from | 25 | 16 | 0.01083 |
| optimal network | | | |

3.5.2 Comparing Gene Networks of Related Species

The methods described can help to unravel differences and similarities in gene regulatory networks of related species such as Gram-positive rod-shaped Bacillus subtilis and Gram-negative rod-shaped Escherichia coli, e.g. by applying the algorithms described to microarray data obtained from time course experiments of both E. coli (experiments for tryptophan metabolism) and B. subtilis and genes known to be involved in the well-studied tryptophan network. We extracted directed motifs based 100 enumerated optimal network models, using 50 as the threshold. A graph was derived from the output file showing the largest motif with the highest hits found in the data sets, genes are presented by nodes and each edge is labeled with its weight.

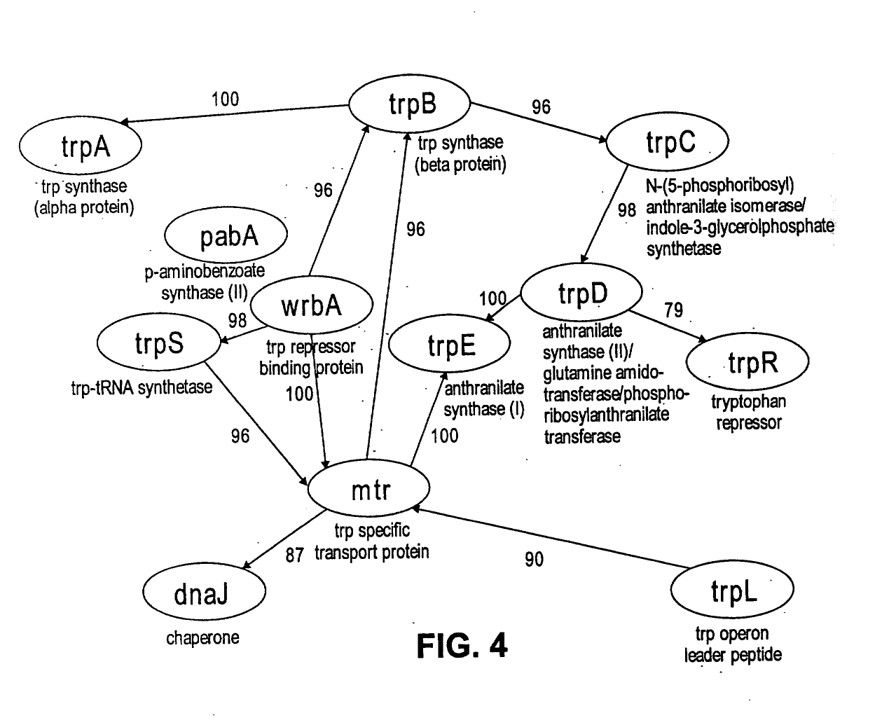

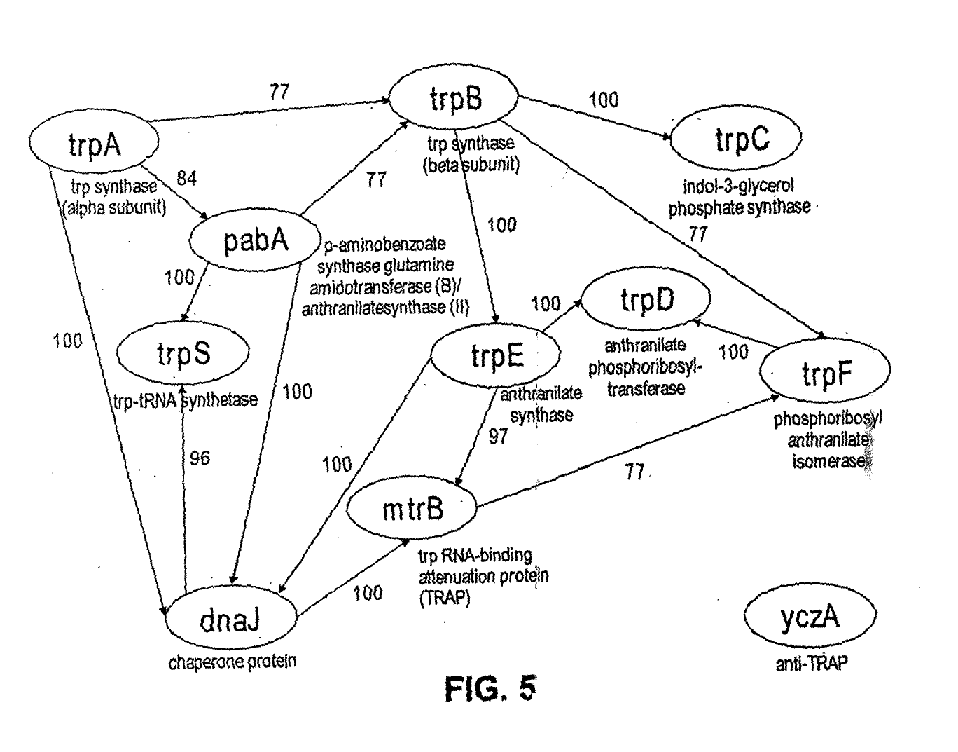

The largest motif obtained the data set for E. coli was found 54 times and contains 13 edges with weights ranging from 79 to 100 (FIG. 4), the one for B. subtilis data was found 61 times and contains 15 edges, weights ranging from 77 to 100 (FIG. 5).

TrpA, trpB, trpC, trpD, trpE are linked by high weighted edges in both motifs, forming the core of this regulatory network, corresponding to the fact that they are positioned close to each other in the trp-operon in both species. Even the order of position in the trp-operon can partially be recognized in the graphs. But in B. subtilis, seven genes code for the enzymes in the trp biosynthesis pathway, as opposed to five in E. coli. The two extra genes, trpF and pabA are also contained in the derived motif. trpF is connected to trpB and trpD, corresponding to its approximate position on the trp-operon. PabA, also called trpG in B. subtilis, is found closely connected to trpA and trpB although it is not located in the trp-operon but in the folate operon citehenner93,gollnick02. This close connection may indicate the close functional relation in the tryptophan biosynthesis pathway. In E. coli there also exists a pabA gene, but the results show no connection to any of the genes in the tryptophan network, consistent with the fact that it has not been found to be involved.

On the other hand, mtrB is closely linked to trpE and trpF in the graph for B. subtilis. This can be explained by the fact that its gene product, tryptophan RNA-binding attenuation protein (TRAP) has been found to be among the key regulators of tryptophan biosynthesis in B. subtilis (24). Interestingly, mtr, coding for a tryptophan specific transport protein in E. coli is also associated with core genes of tryptophan biosynthesis like trpB and trpE in the graph. The structure of the network motifs suggests that the function of mtr in E. coli might be similar to the one of mtrB in B. subtilis.

Recently, a TRAP-inhibitory protein (anti-TRAP, AT) has been found and has been identified as the gene product of yczA (34). However, no association between yczA and the other genes examined can be found in the results. But this maybe due to too low yczA-mRNA levels. Or the AT might be present in the cell throughout, without any need of new translation from yczA-mRNA. This can well be since AT does not act alone but depends on tryptophan levels in the cell and only binds to Trp-activated TRAP (34). No homologue of yczA has been found so far in E. coli, but BLASTP searches revealed that an amino acid sequence of AT shows high similarities to that of cystein-rich domains of the chaperone dnaJ (34). Therefore dnaJ had been included into this calculation, the results suggest an association with the tryptophan network in E. coli and even more in B. subtilis. The reason might be that chaperones can interact with all kinds of pathways. But it might also be caused by cross-hybridization with yczA-mRNA. Or dnaJ does actually play a role in the trp network. Because of the similarity on protein level, it might even function as a TRAP regulator. This would explain the strong link between dnaJ and mtrB in the graph for B. subtilis.

TrpS, coding for the tryptophanyl-tRNA synthetase has been included into this analysis because it had been shown that tRNA^{Trp} plays an important, yet different, role in the regulation of tryptophan biosynthesis in both bacteria. The structures of the respective network motifs differ indeed. The graph for E. coli shows trpS being linked to mtr and wrbA. As mentioned above, mtr codes for a tryptophan specific transport protein (23) and may be involved in transcription termination which can be observed in abundance of tRNA^{Trp} (34), stalling at the leader peptide, which is encoded by trpL, corresponding to the edge from trpL to mtr in the graph. wrbA encodes a tryptophan repressor binding protein, so this edge corresponds to Trp activating the tryptophan repressor. However, there is no direct link between trpS and trpR, the gene coding for the tryptophan repressor. This can be explained by the fact that arrays measure mRNA expression, and the tryptophan repressor protein acts through conformational change when Trp binds, not on the level of transcription. Yet the graph shows an association of trpR with trpD, which may indicate a general production of tryptophan repressor protein together with tryptophan biosynthesis enzymes, though trpR is not located in the trp-operon. In the B. subtilis graph, trpS expression is linked to pabA and dnaJ. If dnaJ functions as yczA, this is consistent with the finding that tRNA^{Trp} has been found to be associated with the formation of AT-inactivated TRAP (34).

However, there are limitations. Microarray data are subject to noise and monitor on mRNA level only. There were only few E. coli data sets (18 arrays); for B. subtilis no experimental data from experiments designed for analysis of tryptophan network had been at the inventor's disposal. But E. coli experiments had been designed for studying tryptophan metabolism, and B. subtilis data sets were obtained from bacteria growing on various media, i.e. under various nutritional conditions. So differences in the tryptophan levels in the media are to be expected, affecting the tryptophan gene regulatory network. Thus, given these data, the tryptophan network was the best target, although the set of genes chosen might not have been optimal, and suitable for evaluating the computational methods described.

3.6. Conclusion

We have provided the theoretical basis for the enumeration of optimal and suboptimal gene network models for gene networks of considerable size, presented results of a comprehensive comparison of optimal models to knowledge, introduced a method for extracting a reliable part of optimal network models, and applied this method.

Extraction of the most reliable motifs from optimal estimations based on state-of-the-art scores is valuable in itself and opens up the way to the analysis of common gene network motifs (network motif in the sense of), comparison of gene networks among related species, and so on.

The algorithmic methodology described in this work is not dependent on a certain scoring scheme or a certain kind of gene expression measurements. Therefore these techniques are generally applicable in all situations, where a score s with functionality s:G×2^{G}!IR is given, which is the case for all scores within the Bayesian network framework, but also for most other score functions. This is an important property for gene network estimation techniques, since work on new scores incorporating previous knowledge such as sequence information (33) or protein interaction data (14, 22) is on-going.

For gene networks of size beyond the computational limits of our algorithm, techniques as in (24) can be applied in order to restrict to a part of the search space that is likely to harbor biologically meaningful networks and to find optimal network models within the selected subspace. We note that our enumeration algorithm can be applied in this case as well, such that our approach of finding gene network motifs is not limited to small gene networks.

Rigorously assessing the accuracy of gene network estimations using available knowledge, as we conducted in Section 3.3, is a promising approach to develop standards for comparing the strength of gene network estimation methods.

Each of the references cited herein are herein incorporated fully by reference.

### REFERENCES

1. T. Chen, H. L. He, G. M. Church. Modeling gene expression with differential equations. Pacific Symposium on Biocomputing, 4: 29-40, 1999.
2. D. M. Chickering. Learning Bayesian networks is NP-complete. In D. Fisher and H.-J. Lenz, editors, Learning from Data: Artificial Intelligence and Statistics V, Springer-Verlag, 1996.
3. G. F. Cooper, E. Herskovits. A Bayesian method for the induction of probabilistic networks from data. Machine Learning, 9: 309-347, 1992.
4. N. Friedman, M. Goldszmidt. Learning Bayesian networks with local structure. Jordan, M. I. (ed.), Kluwer Academic Publishers, pp. 421-459, 1998.
5. N. Friedman, M. Linial, I. Nachman, D. Pe'er. Using Bayesian networks to analyze expression data. Journal of Computational Biology, 7: 601-620, 2000.
6. M. R. Garey, D. S. Johnson. Computers and intractability, W.H. Freeman and Company, 1979.
7. P. Gollnick, P. Babitzke, E. Merino, C. Yanofsky. Bacillus subtilis and its closest relatives: from genes to cells. A. L. Sonenshein, J. A. Hoch, R. Losick. (Eds.), American Society for Microbiology, 2002.
8. A. J. Hartemink, D. K. Gifford, T. S. Jaakkola, R. A. Young. Using graphical models and genomic expression data to statistically validate models of genetic regulatory networks. Pacific Symposium on Biocomputing, 6: 422-433, 2001.
9. A. J. Hartemink, D. K. Gifford, T. S. Jaakkola, R. A. Young. Combining location and expression data for principled discovery of genetic regulatory network models. Pacific Symposium on Biocomputing, 7: 437-449, 2002.
10. L. H. Hartwell, J. J. Hopfield, S. Leibler, A. W. Murray. From molecular to modular cell biology. Nature, 402: C47-C52, 1999.
11. D. Henner, C. Yanofsky. Bacillus subtilis and other gram-positive bacteria: biochemistry, physiology and molecular genetics. A. L. Sonenshein, J. A. Hoch, R Losick. (Eds.), American Society for Microbiology, pp. 269-280, 1993.
12. M. J. L. de Hoon, S. Ott, S. Imoto, S. Miyano. Validation of noisy dynamical system models of gene regulation inferred from time-course gene expression data at arbitrary time intervals. European Conference on Computational Biology, 2003.
13. S. Imoto, T. Goto, S. Miyano. Estimation of genetic networks and functional structures between genes by using Bayesian networks and nonparametric regression. Pacific Symposium on Biocomputing, 7: 175-186, 2002.
14. S. Imoto, T. Higuchi, T. Goto, K. Tashiro, S. Kuhara, S. Miyano. Combining microarrays and biological knowledge for estimating gene networks via Bayesian networks. Proc. 2nd Computational Systems Bioinformatics, 104-113, 2003.
15. S. Imoto, S. Kim, T. Goto, S. Aburatani, K. Tashiro, S. Kuhara, S. Miyano. Bayesian network and nonparametric heteroscedastic regression for nonlinear modeling of genetic network. Journal of Bioinformatics and Computational Biology, in press, 2003; U.S. patent application Ser. No: 10/259,723.
16. T. Ishii, K. Yoshida, G. Terai, Y. Fujita, K. Nakai. DBTBS: A database of Bacillus subtilis promoters and transcription factors. Nucleic Acids Research, 29: 278-280, 2001.
17. A. B. Khodursky, B. J. Peter, M. B. Schmid, J. DeRisi, D. Botstein, P. O. Brown. Analysis of topoisomerase function in bacterial replication fork movement: Use of DNA microarrays. Proceedings of the National Academy of Sciences, 97: 9419-9424, 2000.
18. A. B. Khodursky, B. J. Peter, N. R. Cozzarelli, D. Botstein, P. O. Brown, C. Yanofsky. DNA microarray analysis of gene expression in response to physiological and genetic changes that affect tryptophan metabolism in Escherichia coli. Proceedings of the National Academy of Sciences, 97: 12170-12175, 2000.
19. J. Courcelle, A. Khodursky, B. Peter, P. O. Brown, P. C. Hanawalt. Comparative gene expression profiles following UV exposure in wild-type and SOS-deficient Escherichia coli. Genetics, 158: 41-64, 2001.
20. Y. Makita, M. Nakao, N. Ogasawara, K. Nakai. DBTBS: Database of transcriptional regulation in Bacillus subtilis and its contribution to comparative genomics. submitted for publication.
21. R. Milo, S. Shen-Orr, S. Itzkovitz, N. Kashtan, D. Chklovskii, U. Alon. Network motifs: Simple building blocks of complex networks. Science, 298: 824-827, 2002.
22. N. Nariai, S. Kim, S. Imoto, S. Miyano. Using protein-protein interactions for refining gene networks estimated from microarray data by Bayesian networks. Pacific Symposium on Biocomputing, in press, 2004.
23. I. M. Ong, J. D. Glasner, D. Page. Modelling regulatory pathways in E. coli from time series expression profiles. Bioinformatics, 18: 241-248, 2002.
24. S. Ott, S. Miyano, Finding optimal gene networks using biological constraints, submitted for publication.
25. S. Ott, S. Imoto, S. Miyano. Finding optimal models for small gene networks. Pacific Symposium on Biocomputing, in press, 2004.
26. D. Pe'er, A. Regev, G. Elidan, N. Friedman. Inferring subnetworks from perturbed expression profiles. Bioinformatics, 17: 215-224, 2001.
27. R. W. Robinson. Counting labeled acyclic digraphs. New Directions in the Theory of Graphs, pp. 239-273, 1973.
28. H. Salgado, A. Santos-Zavaleta, S. Gama-Castro, D. Millán-Zárate, E. D″EDaz-Peredo, F. Sánchez-Solano, E. Pérez-Rueda, C. Bonavides-Mart″EDnez, J. Collado-Vides. RegulonDB (version 3.2): transcriptional regulation and operon organization in Escherichia coli K-12. Nucleic Acids Research, 29: 72-74, 2001.
29. S. S. Shen-Orr, R. Milo, S. Mangan, U. Alon. Network motifs in the transcriptional regulation network of Escherichia coli. Nature Genetics, 31: 64-68, 2002.
30. V. A. Smith, E. D. Jarvis, A. J. Hartemink. Evaluating functional network inference using simulations of complex biological systems. Bioinformatics, 18: 216-224, 2002.
31. E. P. van Someren, L. F. A. Wessels, E. Backer, M. J. T. Reinders. Genetic network modeling. Pharmacogenomics, 3(4): 507-525, 2002.
32. A. L. Sonenshein, J. A. Hoch, R. Losick. Bacillus subtilis and its closest relatives: from genes to cells. ASM Press, Washington, D.C., 2001.
33. Y. Tamada, S. Kim, H. Bannai, S. Imoto, K. Tashiro, S. Kuhara, S. Miyano. Estimating gene networks from gene expression data by combining Bayesian network model with promoter element detection. Bioinformatics, in press, 2003.
34. A. Valbuzzi, C. Yanofsky. Inhibition of the B. subtilis regulatory protein TRAP by the TRAP-inhibitory protein, AT. Science, 293: 2057-2059, 2001.
35. http://www.ncbi.nlm.nih.gov/geo/

We claim:

1. A method for inferring a gene network, comprising
(a) providing an inferential model of possible gene networks of an organism including defining a search space;
(b) selecting a biologically relevant subspace of said search space; and
(c) calculating an optimal solution in said selected subspace by repeatedly applying an algorithm that computes small gene networks optimally.

2. The method of claim 1, wherein said inferential model is a Bayesian network estimation model.

3. The method of claim 1, wherein said biologically relevant subspace includes genes relating to a metabolic pathway of said organism.

4. The method of claim 1, wherein said algorithm comprises the steps:
(a) compute F(g,φ)=s(g,φ)) for all g∈G;
(b) for all A⊂G, A≠φ and all g∈G compute F(g,A) as min{s(g,A),min_{a∈A}⁻F(g,A−{a})};
(c) set M(φ)=φ;
(d) for all A⊂G, A≠φ, do the following steps:
(i) compute g*=arg min_{g⊂A}(F(g,A−{g})+Q^{A-{g}}(M(A−{g})))); and
(ii) for all 1≦i<|A|, set M(A)(i)=M(A−{g*})(i), and M(A)(|A|)=g*; and
(e) return Q^{G}(M(G)).

5. The method of claim 4, wherein said algorithm is modified according to the steps of:
(a) in the computation of F in Step 1 and Step 2, compute only F(g,A) for all g∈Sᵢ and all A⊂C_{g}; and
(b). replace the term F(g,A−{g}) in Step 4a by F(g,(C_{g}=Sᵢ)∪(C_{g}∩A)).

6. The method of claim 1, wherein an optimal network N has a definition: score(N)=Σ_{g∈G}_{^{S}}(g,P^{N}(g)).

7. The method of claim 1, wherein said algorithm comprises the steps:
(a) cluster genes in G such that no cluster is larger than c genes;
(b) sort the clusters by decreasing size: C₁, . . . , Cₙ;
(c) for each i∈{1, . . . , n} and for each g∈Cᵢ, select up to m candidate parents from C₁∪ . . . ∪Cₙ; and
(d) compute an optimal gene network model using Theorem 1.2.

8. The method of claim 1, wherein said algorithm comprises the steps:
(a) group genes in G in groups Cᵢ with |Cᵢ|≦c and sort them according to biological knowledge: C₁, . . . , Cₙ;
(b) for each i∈{1, . . . , n} and for each gene g∈Cᵢ, select up to m candidate parents from C₁∪ . . . ∪Cᵢ; and
(c) compute an optimal gene network model using Theorem 2.

9. The method of claim 1, wherein said algorithm comprises the steps:
(a) compute F(g,φ)=s(g,φ)) for all g∈G;
(b) for all A⊂G, A≠φ and all g∈G compute F(g,A) as min{s(g,A),min_{a∈A}⁻F(g,A−{a})};
(cc) set M(φ)=φ;
(d) for all A⊂G, A≠φ, do the following steps:
(i) compute g*=arg min_{g⊂A}(F(g,A−{g})+Q^{A-{g}}(M(A−{g})))); and
(ii) for all 1≦i<|A|, set M(A)(i)=M(A−{g*})(i), and M(A)(|A|)=g*; and
(e) return Q^{G}(M(G)).

10. The method of claim 1, wherein said algorithm comprises the steps:
(a) set F^{m}(g,φ,1)=φ,S^{m}(g,φ,1)=s(g,φ) for all g∈G;
(b) for all g∈G, all A⊂G, A≠N and all n≦m do the following two steps:
(i) select B*⊂A from {B⊂A|B=AvB=F^{m}(g,A−{h},p),h∈A,p≦m}−{F^{m}(g,A,p)|p<n} such that s(g,B*) is minimized; and
(ii) set F^{m}(g,A,n)=B*, S^{m}(g,A,n)=s(gB*);
(c) set M^{m}(φ,1)=φ and D^{m}(φ,1)=φ;
(d) for all A⊂G, φ, and all n≦m do the following three steps:
(i) choose a triple (g,p,q)∈A×IN_{≦m}×IN_{≦m} such that score(Q^{A-{g}}(M^{m}(A−{g},p),D^{m}(A−{g},p)))+S^{m}(g,A−{g},q) is minimized and (g,p,q) induces a network different from Q^{A}(M^{m}(A,r),D^{m}(A,r)) for r<n;
(ii) set M^{m}(A,n)(i)=M^{m}(A−{g},p)(i) for i<|A|, and M^{m}(A,n)(|A|)=g; and
(iii) let v denote D^{m}(A−{g},p). Set w∈IN^{|A|} as wᵢ=vᵢ for all I<|A| and ^{w}|A|=q and set D^{m}(A,n)=w; and
(e) return Q^{G}(M^{m}(G,i),D^{m}(G,i)) for all i≦m.

11. The method of any of claims 1-10, wherein reliability of an enumerated gene network, comprising the steps:
(a) enumerate the most likely gene network models Nᵢ, 1≦i≦n;
(b) for every g,h∈0G, count the occurrences of the edge (g,h) in the networks Nᵢ;
(c) select all edges (g,h) with at least c occurrences;
(d) for all subsets M of the set of selected edges with |M|=k, count the networks including all edges in MI; and
(e) return all motives M with at least c occurrences.

12. The method of any of claims 1-11, further comprising calculating a scoring function selected from the group consisting of BRNC score, BDe score and MDL score.

13. A method for determining a gene network as substantially described herein.

14. A storage medium containing results obtained using the method of any of claims 1-11.

15. A storage medium containing results obtained using a method as substantially described herein.

16. A system for determining gene network relationships, comprising:
an input device for providing quantitative expression data for genes of an organism;
a storage device adapted to receive quantitative expression data for genes of said organism;
a processor adapted to carryout a Bayesian network analysis of network relationships between said genes, thereby producing a data set reflecting said network relationships; and
an output device for displaying said data set of said network relationships.

17. A system for determining gene network relationships as substantially described herein.
